(19) United States
(12) Patent Application Publication
(10) Pub. No.: US 2023/0286386 A1
(43) Pub. Date: Sep. 14, 2023

(54) Propulsion System

(71) Applicant: APPLE INC., Cupertino, CA (US)

(72) Inventors: Peteris K. Augenbergs, Woodside, CA (US); Dillon J. Thomasson, Cupertino, CA (US); Scott Kenyon, South Lyon, MI (US); Philip Steele, Cupertino, CA (US)

(21) Appl. No.: 18/174,881

(22) Filed: Feb. 27, 2023

Related U.S. Application Data
(60) Provisional application No. 63/353,278, filed on Jun. 17, 2022.
(60) Provisional application No. 63/318,673, filed on Mar. 10, 2022.

(51) Int. Cl. B60L 3/00; B60L 15/20

(52) U.S. Cl. CPC B60L 3/0061; B60L 15/20; B60L 2240/423; B60L 2260/28

(57) ABSTRACT

A propulsion system includes a first portion and a second portion that are independently controlled from one another. The first portion includes a first inverter and a first electric motor. The second portion includes a second inverter, a second electric motor, and a second disconnect link. A control system is configured to detect a fault in the first portion, the second portion, or combinations thereof, and determine a response to the fault. In one example, on detection of the fault in the second portion, the second disconnect link is disengaged to reduce electromagnetic drag torque by the second electric motor.

### CROSS-REFERENCE TO RELATED APPLICATIONS

This application claims the benefit of U.S. Provisional Patent Application No. 63/318,673, filed on Mar. 10, 2022, and U.S. Provisional Patent Application No. 63/353,278 filed on Jun. 17, 2022, the contents of which are incorporated by reference in their entireties for all purposes.

### TECHNICAL FIELD

This disclosure relates to a propulsion system.

### BACKGROUND

Electric propulsion systems include a battery and one or more electric motors. It is desirable to include fault tolerance and redundant capabilities in the propulsion system so that mobility can be maintained in the event of a failure in a portion of the propulsion system.

### SUMMARY

Disclosed are implementations of a propulsion system. In one implementation, the propulsion system is an all-wheel-drive (AWD) or four-wheel-drive propulsion system that includes a battery, or one or more batteries that output direct current electrical power to either or both of a first drivetrain or a second drivetrain. In one example the first drivetrain is a front drivetrain of a vehicle and the second drivetrain is a rear drivetrain of the vehicle. The first drivetrain includes a first inverter that receives the direct current electrical power output from the battery, or the one or more batteries and generates a first alternating current electrical power output. A first electric motor is configured to be operated by the first alternating electrical power output from the first inverter to rotate a first motor output shaft to provide a first motor input torque. A first gearbox receives the first motor input torque from the first electric motor and causes rotation of a first gearbox output shaft to provide a first gearbox output torque in response to the first motor input torque. The second drivetrain includes a second inverter that receives the direct current electrical power from the battery, or the one or more batteries and generates a second alternating current electrical power output. A second electric motor is configured to be operated by the second alternating current electrical power output from the second inverter to rotate a second motor output shaft to provide a second motor input torque. A second gearbox receives the second motor input torque from the second motor output shaft and causes rotation of a second gearbox output shaft to provide a second gearbox output torque in response to the second motor input torque.

In one example including the first drivetrain and the second drivetrain, the first inverter receives the direct current electrical power from the battery, or the one or more batteries through a first electrical circuit, and the second inverter receives the direct current electrical power from the battery, or the one or more batteries through a second electrical circuit. The second electrical circuit is independent of the first electrical circuit.

In another example including the first drivetrain and the second drivetrain, the second drivetrain includes a second disconnect link or a second disconnect device configured to move between an engaged position in which the second motor output shaft is connected to the second gearbox so that rotation of the second motor output shaft provides the second motor input torque to the second gearbox. The second disconnect link includes a disengaged position in which the second motor output shaft does not provide the second motor input torque to the second gearbox.

In another example including the first drivetrain and the second drivetrain, the propulsion system includes a control system configured to detect a fault in the first drivetrain, the second drivetrain, or combinations thereof, and determine a response to the fault. In one example, the fault detected by the control system is a single switch short fault, a single switch open fault, a more than one switch short fault, or a six switch open fault, or combinations thereof. In one example, the control system is configured to detect a vehicle speed and the control system is configured to determine a response to the fault according to a vehicle base speed that is predetermined. In one example, on detecting the fault in the first drivetrain, the control system is configured to implement one of a three-phase short condition response in the first electric motor, a six switch open condition response in the first electric motor, or a no reaction response in the first electric motor. In another example, on detecting a fault in the second drivetrain, the control system is configured to move the second disconnect link to the disengaged position to reduce electromagnetic drag torque by the second electric motor.

In an alternate implementation of the propulsion system, the propulsion system includes a single drivetrain, for example a first drivetrain or a second drivetrain, for a two-wheel-drive (2WD) propulsion system that includes one or more batteries that output direct current electrical power to the single drivetrain. The single drivetrain includes a first inverter that receives the direct current electrical power from the one or more batteries and generates a first alternating current electrical power output. A first electric motor is configured to be operated by the first alternating current electrical power output from the first inverter to rotate a first motor output shaft to provide a first input torque. The single drivetrain includes a second inverter that receives the direct current electrical power from the one or more batteries and generates a second alternating current electrical power output. A second electric motor is configured to be operated by the second alternating current electrical power output from the second inverter to rotate a second motor output shaft to provide a second input torque. A single gearbox receives the first input torque from the first motor output shaft of the first electric motor, receives the second input torque from the second motor output shaft of the second electric motor, and causes rotation of a gearbox output shaft to provide a gearbox output torque in response to the first input torque and the second input torque.

In an example of the single drivetrain propulsion system, the single drivetrain includes a disconnect link or disconnect device configured to move between an engaged position in which the first motor output shaft, or the second motor output shaft, is connected to the gearbox so that rotation of the respective first motor output shaft, or the second motor output shaft, provides input torque to the second gearbox. The disconnect link includes a disengaged position in which the respective first motor output shaft, or the second motor output shaft, does not provide motor input torque to the gearbox.

In another example of the single drivetrain propulsion system, the propulsion system includes a control system configured to detect a fault in at least one of the in the first inverter and the first motor pair or the second inverter and the second motor pair and determine a response to the fault. In one example, the fault detected by the control system is a single switch short fault, a single switch open fault, a more than one switch short fault, or a six switch open fault, or combinations thereof. In one example, the control system is configured to detect a vehicle speed and the control system is configured to determine a response to the fault according to a vehicle base speed that is predetermined. In one example, the response is one of a three-phase short condition response in the first electric motor or the second electric motor, a six switch open condition response in the first electric motor or the second electric motor, or a no reaction response in the first electric motor or the second electric motor. In another example, on detecting a fault in the first inverter and the first motor pair or the second inverter and the second motor pair, the control system is configured to move the disconnect link to the disengaged position to reduce electromagnetic drag torque by the disengaged first electric motor or the second electric motor.

### BRIEF DESCRIPTION OF THE DRAWINGS

FIG. 1 is a block diagram of one example of a vehicle.

FIG. 2 is a schematic illustration of one example of a propulsion system including a single drivetrain.

FIG. 3 is a schematic illustration of one example of a propulsion system including a first drivetrain and a second drivetrain.

FIG. 4 is a schematic illustration of one example of use of the propulsion system shown in FIG. 3.

FIG. 5 is a schematic illustration of an alternate example of use of the propulsion system shown in FIG. 3.

FIG. 6 is a block diagram of one example of a control system detection of a fault and determining a response to the fault.

FIG. 7 is a block diagram showing an example of detecting a fault in the second drivetrain and responses to the fault.

FIG. 8 is a block diagram showing an example of detecting a fault in the first drivetrain and responses to the fault.

FIG. 9 is a block diagram of one example of a control system.

### DETAILED DESCRIPTION

Examples of a propulsion system are disclosed. The propulsion system is useful in electric vehicles that may be autonomous, semi-autonomous, or fully-controlled by a driver. In one implementation of the propulsion system, the propulsion system is an all-wheel drive (AWD) propulsion system which is capable of providing electric motor power to one or both of a first drivetrain and/or a second drivetrain. In one example the first drivetrain is a front drivetrain of the vehicle to power or drive a first wheel pair and the second drivetrain is a rear drivetrain of the vehicle to power or drive a second wheel pair. The first drivetrain and the second drivetrain may be independent of one another and lack mechanical connections by which torque can be transferred between the first drivetrain and the second drivetrain. In the AWD configuration, the propulsion system includes a first electric motor to provide electric power to the first drivetrain, and a second electric motor to provide electric power to the second drivetrain. In one example of the AWD configuration, a second disconnect link or second disconnect device is used to selectively disengage the second electric motor from a second gearbox. When the second disconnect link is disengaged, the second electric motor is not rotationally engaged to the second gearbox thereby reducing or eliminating electromagnetic drag of the second electric motor or the second wheel pair, for example the rear wheels of the vehicle, when electric power is not being provided by the second electric motor.

In an alternate implementation of the propulsion system, the propulsion system is a two-wheel-drive (2WD) system including either a first drivetrain or a second drivetrain to provide electric power to either of the first wheel pair, for example the front wheels of the vehicle, or the second wheel pairs, for example the rear wheels of the vehicle, respectively. In this 2WD implementation, two inverter and electric motor pairs are mechanically connected to a single gearbox so that one or both of the two electric motors connected to the single gearbox can provide electric power and electric motor input torque to the single gearbox. In one example, a disconnect link or disconnect device is used to selectively disengage one of the two electric motors from the single gearbox. When the disconnect link is disengaged, the disengaged electric motor is not rotationally engaged to the single gearbox thereby eliminating electromagnetic drag of the disengaged electric motor when electric power is not being provided by that disengaged electric motor.

In electric vehicles, whether in an AWD configuration or a 2WD configuration, it is desirable that the propulsion system operate with a high degree of efficiency to preserve battery charge and maximize the driving range of the electric vehicle. It is also desirable that the propulsion system include fault tolerance and redundant capabilities in the event of a malfunction or failure of a portion of the propulsion system, so the vehicle can maintain mobility for an extended period of time versus an immediate shut down and complete loss of mobility.

In conventional electric vehicles, when a fault occurs in the propulsion system, various devices and features have been employed to completely shut down a portion of the propulsion system, for example an electric motor. Such prior devices have included, for example, pyrotechnic fuses that are configured to rupture or “blow” when certain conditions are met, thereby severing or disabling the electrical circuit to downstream electrical components, for example an electric motor. On rupture of the pyrotechnic fuse, the electrical devices downstream of the pyrotechnic fuse are immediately and completely incapacitated and inoperable to further assist in the continued mobility of the vehicle.

It is desirable to have increased fault tolerance and redundant capabilities or features in the propulsion system that, depending on the fault or malfunction, can induce a response condition or reaction mode of the propulsion system that allows the faulted or malfunctioning portion of the propulsion system to continue to assist on a limited and controlled basis to maintain the mobility of the vehicle.

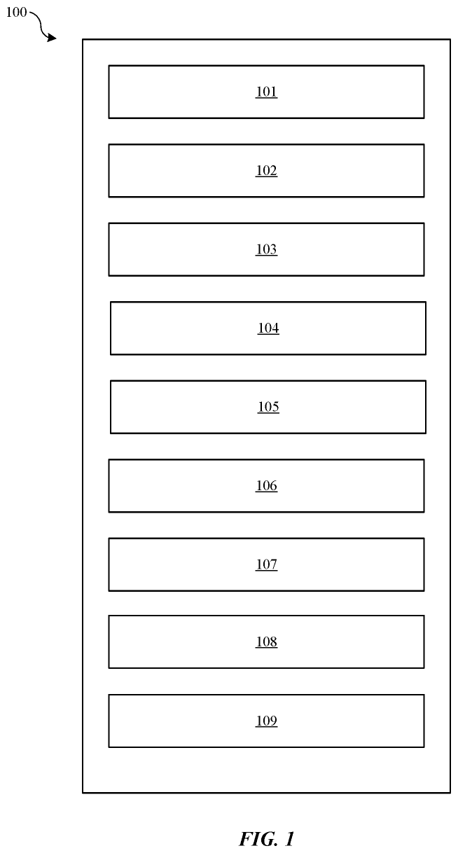

Referring to FIG. 1, a block diagram of a vehicle 100 is shown. As an example, the vehicle 100 may be a conventional road-going vehicle that includes a vehicle body 101 that is supported by wheels 102. As an example, the vehicle 100 may be a passenger vehicle that includes a passenger compartment that is configured to carry one or more passengers. As another example, the vehicle 100 may be a cargo vehicle that is configured to carry cargo items in a cargo compartment. As another example, the vehicle 100 may be a motorcycle. In alternative examples, some or all of the components that are described with respect to the vehicle 100 may be incorporated in different types of vehicles, such as marine vehicles or aircraft.

The vehicle 100 also includes vehicle systems that cause, control, regulate, or otherwise affect motion of the vehicle 100. These systems are connected to the vehicle body 101 and/or the wheels 102 of the vehicle 100. In the illustrated example, the vehicle 100 includes a suspension system 103, a propulsion system 104, a braking system 105, a steering system 106, a sensing system 107, a control system 108, and a battery 109. These are examples of vehicle systems that are included in the vehicle 100. Other systems can be included in the vehicle 100.

The vehicle body 101 is a structural component of the vehicle 100 through which other components are interconnected and supported. The vehicle body 101 may, for example, include or define a passenger compartment for carrying passengers. The vehicle body 101 may include structural components (e.g., a frame, subframe, unibody, monocoque, etc.) and aesthetic components (e.g., exterior body panels). The wheels 102 are connected to the vehicle body 101, for example, by components of the suspension system 103. As an example, the wheels 102 may include four wheels that support the vehicle, and each of the wheels 102 may have a pneumatic tire mounted thereto. The suspension system 103 supports a sprung mass of the vehicle 100 with respect to an unsprung mass of the vehicle 100. The suspension system 103 is configured to control vertical motion of the wheels of the vehicle 100 relative to the vehicle body 101, for example, to ensure contact between the wheels and a surface of a roadway and to reduce undesirable movements of the vehicle body 101.

The propulsion system 104 includes propulsion components that are configured to cause motion of the vehicle 100 (e.g., by causing the vehicle 100 to accelerate). The propulsion system 104 may include components such that are operable to generate torque and deliver that torque to one or more wheels 102 (e.g., road wheels that contact the road through tires mounted on the road wheels). Examples of components that may be included in the propulsion system 104 include inverters, motors, gearboxes, and propulsion linkages (e.g., drive shafts, half shafts, etc.). Specific configurations of the propulsion system 104 will be described in detail herein.

The braking system 105 provides deceleration torque for decelerating the vehicle 100. The braking system 105 may include friction braking components such as disk brakes or drum brakes. The braking system 105 may use an electric motor of the propulsion system 104 to decelerate the vehicle by electromagnetic resistance, which may be part of battery charging in a regenerative braking configuration. The steering system 106 is operable to cause the vehicle to turn by changing a steering angle of one or more wheels 102 of the vehicle 100, for example using actuators or a manually operated steering device.

The sensing system 107 includes sensors for observing external conditions of the environment around the vehicle 100 (e.g., location of the roadway and other objects) and conditions of the vehicle 100 (e.g., acceleration and internal conditions of the various vehicle systems and their components). The sensing system 107 may include sensors of various types, including dedicated sensors and/or components of the various systems. For example, actuators may incorporate sensors or portions of actuators may function as sensors such as by measuring current draw of an electric motor or by sensing the position of an output shaft of an electric motor. Other sensors may monitor and/or detect states or characteristics of the vehicle system components, for example, the positions of electrical switches, the flow of electrical current at electrical contacts, and/or other states or conditions of mechanical or electrical components of the various vehicle systems. Conditions monitored by the sensing system 107 may include a vehicle speed and acceleration of the vehicle 100, a motor speed, acceleration, and torque value for each of the motors that is included in the propulsion system 104, and a wheel speed for each of the wheels 102 of the vehicle 100.

The control system 108 includes communication components (i.e., for receiving sensor signals and sending control signals), and processing components (i.e., for processing the sensor signals and determining control operations), such as a controller. The control system 108 may be a single system or multiple related systems. For example, the control system 108 may be a distributed system including components that are included in other systems of the vehicle 100, such as the suspension system 103, the propulsion system 104, the braking system 105, the steering system 106, the sensing system 107, and/or other systems.

The battery 109 is an electrical energy storage device (e.g., including many individual electrochemical cells) that is configured to supply electrical power to the other systems of vehicle 100, including, for example, the propulsion system 104. The battery 109 can be charged and discharged. The battery 109 can be charged, for example, by the supply of electrical power from an external power source or by supply of electrical power from the propulsion system 104 during regenerative braking.

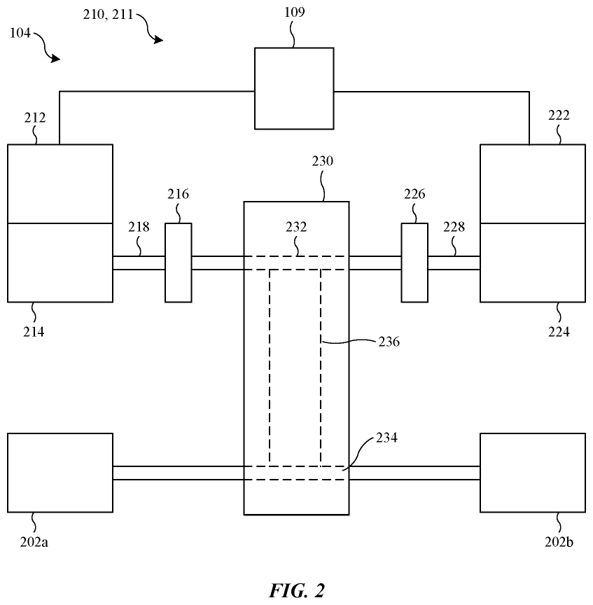

Referring to FIG. 2, one implementation of the propulsion system 104 is shown in the configuration of the 2WD propulsion system including a drivetrain (e.g., a single drivetrain). The drivetrain may be used as a first drivetrain 210 (for example a front drivetrain if the vehicle 100 is configured as a front-wheel-drive vehicle), or as a second drivetrain 211 (for example a rear drivetrain if the vehicle 100 is configured as rear-wheel-drive vehicle). In one example, the vehicle 100 is an electric vehicle which is powered solely by power supplied by the battery 109 and is propelled solely by the drivetrain (e.g., the vehicle 100 does not include an internal combustion engine).

The first drivetrain 210 (only the first drivetrain 210 will be explained for ease of convenience, the second drivetrain 211 is substantially similar) includes a first inverter 212, a first electric motor 214, a first disconnect link or first disconnect device 216, a second inverter 222, a second electric motor 224, a second disconnect link or second disconnect device 226, and a gearbox 230. The gearbox 230 drives or provided power to a first wheel pair 202a, 202b, which are individual ones of the wheels 102 of the vehicle 100. The gearbox 230 may drive the first wheel pair 202a, 202b through a differential device (not shown), that allows each of the wheels of the first wheel pair 202a, 202b to rotate independently of each other, and is implemented according to conventional designs. The first inverter 212 and the second inverter 222 are each electrically connected to the battery 109 (or to a separate battery) and are configured to receive the direct current electrical power output from the one or more batteries. The battery 109 (e.g., one or more batteries) outputs direct current electrical power and supplies the direct current electrical power to the first inverter 212 and the second inverter 222. In the illustrated example, the first inverter 212 and the second inverter 222 are connected to the battery 109 (e.g., both are connected to a single battery), but in alternative examples, each of the first inverter 212 and the second inverter 222 may be connected to a separate battery. Thus, electrical power may be supplied to the first inverter 212 and the second inverter 222 by one or more batteries, such as the battery 109 and additional batteries that are equivalent to the battery 109.

The first inverter 212 and the second inverter 222 are each controlled to output alternating current electrical power. The first inverter 212 and the second inverter 222 receive the direct current electrical power from the battery 109 (or from one or more batteries). Using the direct current electrical power from the battery 109 (or from one or more batteries), the first inverter 212 generates a first alternating current electrical power output and the second inverter 222 generates a second alternating current electrical power output.

The first inverter 212 is paired with and electrically connected to the first electric motor 214 to supply the alternating current electrical power (e.g., the first alternating current electrical power output) to the first electric motor 214. The second inverter 222 is paired with and electrically connected to the second electric motor 224 to supply alternating current electrical power (e.g., the second alternating current electrical power output) to the second electric motor 224. As an example, the first inverter 212 may supply three-phase alternating current electrical power to the first electric motor 214 and the second inverter 222 may supply three-phase alternating current electrical power to the second electric motor 224.

The first inverter 212 and the second inverter 222 may be implemented using conventional inverter designs. For example, the first inverter 212 and the second inverter 222 may be implemented using a switching-type inverter design that implements variable frequency drive to control speed and torque of the first electric motor 214 and the second electric motor 224 by varying the frequency and the voltage of the alternating current electrical power that is supplied to the first electric motor 214 and the second electric motor 224, respectively. In one example, the first inverter 212 and the second inverter 222 each include six switches (e.g., three pairs of positive and negative switches each including an open position and a closed position. Each pair of the positive and negative switches corresponding to a respective phase of the three-phase alternating current electrical power output from the inverter). In normal operation, the first inverter 212 and the second inverter 222 operate to supply the three-phase alternating current by rapid, controlled switching between the open and closed positions of the respective pair of switches. It is understood that alternate inverter designs may be used, for example inverters with fewer switch pairs, or additional switch pairs, or alternately configured inverters, depending on the application as known by persons skilled in the art.

The first electric motor 214 is configured to be operated by the first alternating current electrical power output that is generated by the first inverter 212 to provide a first input torque to the gearbox 230. The second electric motor 224 is configured to be operated by the second alternating current electrical power output that is generated by the second inverter 222 to provide a second input torque to the gearbox 230. The terms first input torque and second input torque refer to the contributions of the first electric motor 214 and the second electric motor 224 to the gearbox 230, but are combined when input to the gearbox 230. As illustrated, the gearbox 230 receives the first input torque and the second input torque at a common input shaft (i.e., gearbox input shaft 232), but the gearbox 230 may be of an alternate configuration, for example a gearbox input shaft 232 and a separate intermediate gearbox input shaft (not shown). In one example, the first electric motor 214 may be engaged with the gearbox input shaft 232, and the second electric motor 224 may be engaged with the intermediate shaft. Other configurations of the gearbox 230 may be used depending on the application as known by persons skilled in the art.

The first electric motor 214 is an electrically operated motor, which may be implemented according to any known design. Specific examples of the first electric motor 214 will be described further herein. The first electric motor 214 causes rotation of a first motor output shaft 218 by electromagnetic interaction of a rotor and a stator, with the first motor output shaft 218 being connected to the rotor so that it is rotated by the rotor. The first motor output shaft 218 is connected to the gearbox 230, as will be explained herein, so that a torque that is generated by the first electric motor 214 (e.g., a first input torque) is provided to the gearbox 230. Thus, the first electric motor 214 is controllable, by operation of the first inverter 212, to selectively apply the first input torque to the gearbox 230 when the first electric motor 214 is operating. During regenerative braking, the first motor output shaft 218 of the first electric motor 214 is rotated by torque from the gearbox 230 to generate electric power that is returned to the battery 109.

In the FIG. 2 example, the first electric motor 214 is connected to the gearbox 230 by the first disconnect link 216, which allows for rotational connection and disconnection of the first electric motor 214 and the gearbox 230. The first motor output shaft 218 connects the first electric motor 214 to the first disconnect link 216. The gearbox input shaft 232 connects the gearbox 230 to the first disconnect link 216. It should be understood that, in alternate examples (not shown), the first disconnect link 216 may be omitted, and the first motor output shaft 218 may be connected to the gearbox input shaft 232 so that they rotate in unison and cannot be rotationally disconnected.

The first disconnect link 216 is a mechanical link or mechanical device that is configured to selectively transmit torque between first and second rotatable components, which in the FIG. 2 example, are the first motor output shaft 218 of the first electric motor 214 and the gearbox input shaft 232 of the gearbox 230. Thus, the first disconnect link 216 may be controlled to establish a torque-transmitting connection between the first motor output shaft 218 and the gearbox input shaft 232. The first disconnect link 216 is an electromechanical system (e.g., clutch controlled by an electrical actuator, solenoid, etc.) that can be controlled by commands (e.g., signals and/or data) that are sent to the first disconnect link 216 by another system, such as the control system 108. Thus, the first disconnect link 216 may include a controllable actuator (not shown). The controllable actuator may be integrated with the other structures of the first disconnect link 216, or the controllable actuator may be remote from other structures of the first disconnect link 216 and use a mechanical or hydraulic linkage to engage and disengage the first disconnect link 216. In one example (not shown), the first disconnect link 216 may include a separate controller (not shown) that is in communication with the controllable actuator and another system, for example the control system 108, as described above.

The first disconnect link 216 is configured to move between an engaged position and a disengaged position. In the engaged position of the first disconnect link 216, the first disconnect link 216 transmits torque from the first motor output shaft 218 to the gearbox input shaft 232 (or other torque receiving input structure of the gearbox 230). Thus, in the engaged position, rotation of the first motor output shaft 218 by the first electric motor 214 provides an input torque to the gearbox 230. In the disengaged position of the first disconnect link 216, the first disconnect link 216 has disconnected the torque-transmitting connection of the first motor output shaft 218 and the gearbox input shaft 232 so that they rotate independently of each other and torque is not transmitted between the first motor output shaft 218 and the gearbox input shaft 232. Thus, the first disconnect link 216 moves between the engaged position in which the first motor output shaft 218 is connected to the gearbox 230 so that rotation of the first motor output shaft 218 provides the first input torque to the gearbox 230, and the disengaged position in which the first motor output shaft 218 is rotationally disconnected from the gearbox 230 so that rotation of the first motor output shaft 218 does not provide the first input torque to the gearbox 230. Thus, the first motor output shaft 218 is mechanically and rotationally coupled to the gearbox input shaft 232 of gearbox 230 by the first disconnect link 216 in the engaged position, and the first motor output shaft 218 is not rotationally coupled to the gearbox input shaft 232 of the gearbox 230 by the first disconnect link 216 in the disengaged position. When the first disconnect link 216 is in the engaged position, the first motor output shaft 218 of the first electric motor 214 may rotate in unison with the gearbox input shaft 232. When the first disconnect link 216 is in the disengaged position, the first electric motor 214 is able to rotate independent of the gearbox input shaft 232 so that the speed of the first motor output shaft 218 is not constrained to be equal to the speed of the gearbox input shaft 232.

The second electric motor 224 is an electrically operated motor, which may be implemented according to any known design. Specific implementations of the second electric motor 224 will be described further herein. The second electric motor 224 causes rotation of a second motor output shaft 228 by electromagnetic interaction of a rotor and a stator, with the second motor output shaft 228 being connected to the rotor so that it is rotated by the rotor. The second motor output shaft 228 is connected to the gearbox 230, as will be explained herein, so that a torque that is generated by the second electric motor 224 (e.g., a second input torque) is provided to the gearbox 230. Thus, the second electric motor 224 is controllable, by operation of the second inverter 222, to selectively apply the second input torque to the gearbox 230 when the second electric motor 224 is operating. During regenerative braking, the second motor output shaft 228 of the second electric motor 224 is rotated by torque from the gearbox 230 to generate electric power that is returned to the battery 109.

In the FIG. 2 example, the second electric motor 224 is connected to gearbox 230 by the second disconnect link 226, which allows for rotational connection and disconnection of the second electric motor 224 and the gearbox 230. The second motor output shaft 228 connects the second electric motor 224 to the second disconnect link 226. The gearbox input shaft 232 connects the gearbox 230 to the second disconnect link 226. It should be understood that, in alternate examples (not shown), the second disconnect link 226 may be omitted, and the second motor output shaft 228 may be connected to the gearbox input shaft 232 so that they rotate in unison and cannot be rotationally disconnected. In this alternate example (not shown) wherein the second disconnect link 226 is omitted, it is understood that the first disconnect link 216 may be included and used in the first drivetrain 210 to rotationally connect or disconnect the first motor output shaft 218 to the gearbox input shaft 232 as described above. Equally, it is understood that in the example wherein the first disconnect link 216 is omitted, the second disconnect link 226 may be included and used in the first drivetrain 210 to connect or disconnect the second motor output shaft 228 to the gearbox input shaft 232 as described above. In an alternate example (not shown) the first disconnect link 216 and/or the second disconnect link 226 may be positioned inside the gearbox 230 (e.g., coupled to the gearbox input shaft 232 or the gearbox output shaft 234) or positioned between the gearbox 230 and the respective one of the first wheel pair 202a, 202b.

The second disconnect link 226 is a mechanical link or mechanical device that is configured to selectively transmit torque between first and second rotatable components, which in the FIG. 2 example are the second motor output shaft 228 of the second electric motor 224 and the gearbox input shaft 232 of the gearbox 230. Thus, second disconnect link 226 may be controlled to establish a torque-transmitting connection between the second motor output shaft 228 and the gearbox input shaft 232. The second disconnect link 226 is an electromechanical system (e.g., clutch controlled by electrical actuator, solenoid, etc.) that can be controlled by commands (e.g., signals and/or data) that are sent to the second disconnect link 226 by another system, such as the control system 108. Thus, second disconnect link 226 may include a controllable actuator. The controllable actuator may be integrated with the other structures of the second disconnect link 226, or the controllable actuator may be remote from other structures of the second disconnect link 226 and use a mechanical or hydraulic linkage to engage and disengage the second disconnect link 226. In one example (not shown), the second disconnect link 226 may include a separate controller (not shown) that is in communication with the controllable actuator and another system, for example the control system 108, as described above.

The second disconnect link 226 is configured to move between an engaged position and a disengaged position. In the engaged position of the second disconnect link 226, the second disconnect link 226 transmits torque from the second motor output shaft 228 to the gearbox input shaft 232. Thus, in the engaged position, rotation of the second motor output shaft 228 by the second electric motor 224 provides an input torque to the gearbox 230. In the disengaged position of the second disconnect link 226, the second disconnect link 226 has disconnected the torque-transmitting connection of the second motor output shaft 228 and the gearbox input shaft 232 so that they rotate independently of each other and torque is not transmitted between the second motor output shaft 228 and the gearbox input shaft 232. Thus, the second disconnect link 226 moves between the engaged position in which the second motor output shaft 228 is connected to the gearbox 230 so that rotation of the second motor output shaft 228 provides the second input torque to the gearbox 230, and the disengaged position in which the second motor output shaft 228 is rotationally disconnected from the gearbox 230 so that rotation of the second motor output shaft 228 does not provide the second input torque to the gearbox 230. Thus, the second motor output shaft 228 is mechanically and rotationally coupled to the gearbox input shaft 232 of gearbox 230 by the second disconnect link 226 in the engaged position, and the second motor output shaft 228 is not rotationally coupled to the gearbox input shaft 232 of the gearbox 230 by the second disconnect link 226 in the disengaged position. When the second disconnect link 226 is in the engaged position, the second motor output shaft 228 of the second electric motor 224 may rotate in unison with the gearbox input shaft 232. When the second disconnect link 226 is in the disengaged position, the second electric motor 224 is able to rotate independent of the gearbox input shaft 232 so that the speed of the second motor output shaft 228 is not constrained to be equal to the speed of the gearbox input shaft 232. As described above, in one example (not shown), the second disconnect link 226 may be omitted.

In one example of the gearbox 230 shown in FIG. 2, The gearbox 230 includes the gearbox input shaft 232, a gearbox output shaft 234, and a gear train 236. The gearbox 230 may also include other components that are not shown in the illustrated implementation, such as conventional components that are included in known gearbox designs as will be appreciated by persons of skill in the art. The gearbox 230 establishes a geared relationship of the gearbox input shaft 232 and the gearbox output shaft 234 (e.g., for gear reduction of the output of the first electric motor 214 and the second electric motor 224) so that the gearbox output shaft 234 rotates in response to one or both of the first input torque and the second input torque. The gearbox 230 receives the first input torque and/or the second input torque from the first electric motor 214 and the second electric motor 224. The gearbox 230 is connected, directly or indirectly (e.g., through the differential device, not shown), to the first wheel pair 202a, 202b by the gearbox output shaft 234 so that an output torque is applied to the gearbox output shaft 234 by the gear train 236 and is provided to drive or power one or both of the wheels of the first wheel pair 202a, 202b, for example, to cause motion of the vehicle 100.

The first inverter 212, the first electric motor 214, the second inverter 222, and the second electric motor 224 may be implemented using different designs and/or motor topologies in order to optimize the first electric motor 214 and the second electric motor 224 for different operating conditions.

To achieve desired operating characteristics, the design and operation of the first inverter 212 and the first electric motor 214 may be optimized as a pair. The design and operation of the second inverter 222 and the second electric motor 224 may likewise be optimized as a pair.

As one example, the first electric motor 214 is optimized for operation in a first operating speed range, and the second electric motor 224 is optimized for operation in a second operating speed range, wherein at least part of the second operating speed range is higher than a maximum operating speed of the first operating speed range. In another example, the first electric motor 214 is optimized for operation in a first torque range, and the second electric motor 224 is optimized for operation in a second torque range, wherein at least part of the first torque range is higher than a maximum operating torque, or maximum torque, of the second torque range. In one example of the FIG. 2 drivetrain configuration as described above, the first inverter 212, the first electric motor 214, the second inverter 222, and the second electric motor 224 are positioned and/or configured to provide the first motor input torque and the second motor input torque to drive or power the first wheel pair 202a, 202b positioned toward a front of the vehicle 100 (i.e., a vehicle configured for front-wheel-drive). In an alternate example, the first inverter 212, the first electric motor 214, the second inverter 222, and the second electric motor 224 are positioned and/or configured to provide the first motor input torque and the second motor input torque to drive or power the first wheel pair 202a, 202b positioned toward a rear of the vehicle 100 (i.e., a rear-wheel-drive vehicle).

To achieve different operating characteristics, the first electric motor 214 and the second electric motor 224 may use different motor architectures. These may be based on known designs, such as interior permanent magnet designs, surface mount permanent magnet designs, axial flux designs, and radial flux designs, and by using either of thick laminations with high permeability or thin laminations with low core loss. In one example of the first electric motor 214 and the second electric motor 224, each motor is configured as a three-phase induction motor. In one example, the above-described stator includes three pairs of wire coils (two pole electric motor) angularly spaced from each other (i.e., 120 degrees apart), each respective pair of wire coils is electrically connected to one phase of the three-phase electrical power (i.e., the alternating current electrical power output) received from the first inverter 212 and the second inverter 222, respectively. The out-of-phase electric coils generate a rotating magnetic field which generates rotation of the above-described rotor. In alternate examples, the first electric motor 214 and/or the second electric motor 224 may be a four pole, a six pole, an eight pole, or alternate pole, stator configuration. As described, the first inverter 212, the second inverter 222, the first electric motor 214, and the second electric motor 224 can take other architectures, configurations, forms, and operations depending on the application as known by persons skilled in the art.

As described above, in one example (not shown), the propulsion system 104 includes the first disconnect link 216 but omits the second disconnect link 226. In this example, the control system 108 is operable to switch or alternate the propulsion system 104 of the vehicle 100 between a first operating mode, a second operating mode, and a third operating mode, based on operating characteristics of the vehicle 100, such as a vehicle speed of the vehicle 100, an operating speed of the first electric motor 214, an operating speed of the second electric motor 224, an operating torque of the first electric motor 214 and/or an operating torque of the second electric motor 224. As an example, in the first operating mode, the first electric motor 214 provides the first input torque to the gearbox 230, the second electric motor 224 does not provide the second input torque to the gearbox 230, and the first disconnect link 216 is in the engaged position. As an example, in the second operating mode, the first electric motor 214 provides the first input torque to the gearbox 230, the second electric motor 224 provides the second input torque to the gearbox 230, and the first disconnect link 216 is in the engaged position. In the third operating mode, the first electric motor 214 does not provide the first input torque to the gearbox 230, the second electric motor 224 provides the second input torque to the gearbox 230, and the first disconnect link 216 is in the disengaged position.

In another example (not shown), the propulsion system 104 includes the first disconnect link 216 and the second disconnect link 226. In this implementation, the control system 108 is operable to switch the propulsion system 104 of the vehicle 100 between a first operating mode, a second operating mode, and a third operating mode, based on operating characteristics of the vehicle 100, such as a vehicle speed of the vehicle 100. As an example, in the first operating mode, the first electric motor 214 provides the first input torque to the gearbox 230, the second electric motor 224 does not provide the second input torque to the gearbox 230, the first disconnect link 216 is in the engaged position, and the second disconnect link 226 is in the disengaged position. As an example, in the second operating mode, the first electric motor 214 provides the first input torque to the gearbox 230, the second electric motor 224 provides the second input torque to the gearbox 230, the first disconnect link 216 is in the engaged position, and the second disconnect link 226 is in the engaged position. In the third operating mode, the first electric motor 214 does not provide the first input torque to the gearbox 230, the second electric motor 224 provides the second input torque to the gearbox 230, the first disconnect link 216 is in the disengaged position, and the second disconnect link 226 is in the engaged position. In an alternate example not shown, it is understood that use of the first operating mode, the second operating mode, or the third operating mode may be used without use of both of the first disconnect link 216 and the second disconnect link 226 (i.e., the first disconnect link 216 and the second disconnect link 226 are omitted).

In implementations in which the control system 108 controls the propulsion system in one of a first operating mode, a second operating mode, or a third operating mode, as previously described, the control system 108 may be configured to select the operating mode based on speed ranges for the vehicle speed, based on the rotational speeds of one or both of the first electric motor 214 and the second electric motor 224, based on operating torque values for one or both of the first electric motor 214 and the second electric motor 224, and/or based on the rotational speed of other components of the propulsion system 104, such as the differential device, or one or both of the wheels of the first wheel pair 202a, 202b. As one example, the control system 108 may be configured to select the first operating mode when a vehicle speed is in a first range, the control system 108 may be configured to select the second operating mode when the vehicle speed is in a second range that is higher than the first range, and the control system 108 may be configured to select the third operating mode when the vehicle speed is in a third range that is higher than the second range. As another example, the control system 108 may be configured to select the third operating mode when an operating torque is in a first torque range, the control system 108 may be configured to select the first operating mode when the operating torque is in a second torque range that is higher than the first torque range, and the control system 108 may be configured to select the second operating mode when the operating torque is in a third torque range that is higher than the second torque range. As another example, the control system 108 may be configured to select one of the first operating mode, the second operating mode, or the third operating mode based on a vehicle speed and an operating torque. For instance, torque ranges corresponding to selection of each of the first operating mode, the second operating mode or the third operating mode (along with threshold torque values between the ranges) may vary as a function of the vehicle speed or motor speed. The first, second, and third operating ranges may be described, for example, by a two dimensional mapping of motor torque and motor speed.

In the FIG. 2 example, in addition to improving efficiency, the propulsion system 104 also provides redundancy by allowing operation of the propulsion system using only the first electric motor 214 or only the second electric motor 224. For example, on a failure or a fault of the first electric motor 214 or the first inverter 212, the second electric motor 224 can be switched on, and the first electric motor 214 can be switched off. Additionally, the second disconnect link 226 can be moved to the engaged position and/or the first disconnect link 216 can be moved to the disengaged position. As another example, on a failure or a fault of the second electric motor 224 or the second inverter 222, the first electric motor 214 can be switched on, and the second electric motor 224 can be switched off. Additionally, the second disconnect link 226 can be moved to the disengaged position and/or the first disconnect link 216 can be moved to the engaged position.

The propulsion system 104 also allows control according to an optimal efficiency torque split control strategy, which means that, for a given total torque command (e.g., as requested by the control system 108) at a given speed, the control system 108 apportions the torque command between the first electric motor 214 and the second electric motor 224 in a manner that results in the lowest electrical energy consumption (and therefore highest efficiency).

The control system 108 may be configured to determine whether the propulsion system 104 should be operated according to the optimal efficiency torque split control strategy, which will typically be the primary control strategy that is selected in order to maximize the range of the vehicle 100. Other strategies may be used under specific conditions, for example, for active thermal balancing of the motors and inverters to prevent components from reaching their thermal limits, or for wear accumulation balancing to extend the total life of the propulsion system 104 by modifying allocation of effort between the first electric motor 214 and the second electric motor 224.

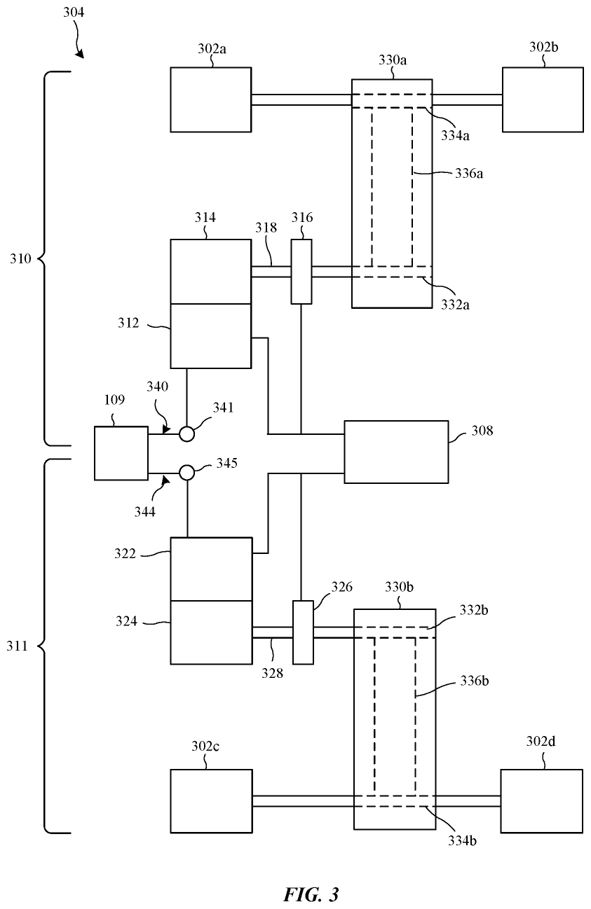

Referring to FIG. 3, an alternate implementation of propulsion system 104 is illustrated. In the example, the propulsion system 304 is configured in an all-wheel-drive (AWD) (or four-wheel-drive) configuration including a first drivetrain 310 and a second drivetrain 311. In the illustrated implementation, the first drivetrain 310 and the second drivetrain 311 are mechanically independent, such that no torque is transferred between the first drivetrain 310 and the second drivetrain 311 by a mechanical interconnection between them.

The first drivetrain 310 includes a first inverter 312, a first electric motor 314, a first disconnect link or first disconnect device 316, and a first gearbox 330a. The first gearbox 330a drives or powers one or both wheels of the first wheel pair 302a, 302b, which are individual ones of the wheels 102 of the vehicle 100. In the illustrated example, first gearbox 330a drives or powers one or both wheels of the first wheel pair 302a, 302b through a differential device (not shown), that allows each one of the first wheel pair 302a, 302b to rotate independently of each other, and is implemented according to conventional designs. In one example of the FIG. 3 implementation, the first inverter 312, the first electric motor 314, and the first disconnect link 316 are configured and function as generally described for the first inverter 212, the first electric motor 214, and the first disconnect link 216 for the example implementation in FIG. 2 and as further described below. The first inverter 312 is electrically connected to the battery 109 (or to a separate battery) described in further detail below. The battery 109 (e.g., one or more batteries) outputs direct current electrical power and supplies the direct current electrical power to the first inverter 312. In the illustrated FIG. 3 example, the first inverter 312 is connected to the battery 109. The electrical power may be supplied to the first inverter 312 by one or more batteries. The components, structure, and operation of the first inverter 312, and the described alternate configurations thereto, is the same or similar as described above for the first inverter 212 in the FIG. 2 example.

The first electric motor 314 is configured to be operated by a first alternating current electrical power output that is generated by the first inverter 312 to cause rotation of a first motor output shaft 318 to provide a first input torque to the first gearbox 330a. The components, structure, and operation of the first electric motor 314, and the described alternative configurations thereto, is the same or similar as described above for the first electric motor 214 in the FIG. 2 example.

In the FIG. 3 example, the first electric motor 314 is connected to the first gearbox 330a by the first disconnect link 316, which allows for rotational connection and disconnection of the first electric motor 314 and the first gearbox 330a in the manner described above for the first disconnect link 216 in the FIG. 2 example. The first motor output shaft 318 connects the first electric motor 314 to the first disconnect link 316. A first gearbox input shaft 332a connects the first gearbox 330a to the first disconnect link 316. As described above for the FIG. 2 example, it should be understood that, in alternate examples (not shown), the first disconnect link 316 may be omitted, and the first motor output shaft 318 may be connected to the first gearbox input shaft 332a so that they rotate in unison and cannot be rotationally disconnected in the manner described above. As described above for the FIG. 2 example, the first disconnect link 316 may be omitted, and the second disconnect link 326 described below may be used.

The first disconnect link 316 is configured to move between an engaged position and a disengaged position. In the engaged position of the first disconnect link 316, the first disconnect link 316 transmits torque from the first motor output shaft 318 to the first gearbox input shaft 332a (or other torque receiving input structure of the first gearbox 330a). Thus, in the engaged position, rotation of the first motor output shaft 318 by the first electric motor 314 provides a first input torque to the first gearbox 330a. In the disengaged position of the first disconnect link 316, the first disconnect link 316 has disconnected the torque-transmitting connection of the first motor output shaft 318 and the first gearbox input shaft 332a so that they rotate independently of each other and torque is not transmitted between the first motor output shaft 318 and the first gearbox input shaft 332a. Thus, the first disconnect link 316 moves between the engaged position in which the first motor output shaft 318 is connected to the first gearbox 330a so that rotation of the first motor output shaft 318 provides the first input torque to the first gearbox 330a, and the disengaged position in which the first motor output shaft 318 is rotationally disconnected from the first gearbox 330a so that rotation of the first motor output shaft 318 does not provide the first input torque to the first gearbox 330a. The components, structure, and operation of the first disconnect link 316, and the described alternative configurations thereto, is the same or similar as described above for the first disconnect link 216 in the FIG. 2 example.

The first gearbox 330a includes the first gearbox input shaft 332a, a first gearbox output shaft 334a, and a first gear train 336a. The first gearbox 330a establishes a geared relationship of the first gearbox input shaft 332a and the first gearbox output shaft 334a (e.g., for gear reduction of the output of the first electric motor 314 so that the first gearbox output shaft 334a rotates in response to the first input torque. The first gearbox 330a receives the first input torque from the first electric motor 314 and causes rotation of the first gearbox output shaft 334a to provide the first gearbox output torque in response to the first motor input torque. The first gearbox 330a is connected, directly or indirectly (e.g., through the differential device, not shown), each one of the first wheel pair 302a, 302b by the first gearbox output shaft 334a so that an output torque is applied to the first gearbox output shaft 334a by the first gear train 336a and is provided to one or both wheels of the first wheel pair 302a, 302b, for example, to cause motion of the vehicle 100. The components, structure, and operation of the first gearbox 330a, and the described alternative configurations thereto, is the same or similar as described above for the gearbox 230 in the FIG. 2 example.

The second drivetrain 311 includes a second inverter 322, a second electric motor 324, a second disconnect link or second disconnect device 326, and a second gearbox 330b. The second gearbox 330b drives or powers one or both wheels of the second wheel pair 302c, 302d, which are individual ones of the wheels 102 of the vehicle 100. In the FIG. 3 example, second gearbox 330b drives or powers one or both wheels of the second wheel pair 302c, 302d through a differential device (not shown), that allows each of the wheels of the second wheel pair 302c, 302d to rotate independently of each other, and is implemented according to conventional designs. In one example of the FIG. 3 implementation, the second inverter 322, the second electric motor 324, and the second disconnect link 326 are configured and function as generally described for the second inverter 222, the second electric motor 224, and the second disconnect link 226 for the example implementation in FIG. 2 and as further described below. The second inverter 322 is electrically connected to the battery 109 (or to a separate battery) described in further detail below. The battery 109 (e.g., one or more batteries) outputs direct current electrical power and supplies the direct current electrical power to the second inverter 322. In the illustrated FIG. 3 example, the second inverter 322 is connected to the battery 109. The electrical power may be supplied to the second inverter 322 by one or more batteries. The components, structure, and operation of the second inverter 322, and the described alternate configurations thereto, is the same or similar as described above for the second inverter 222 in the FIG. 2 example.

The second electric motor 324 is configured to be operated by the second alternating current electrical power output that is generated by the second inverter 322 to cause rotation of a second motor output shaft 328 to provide a second input torque to the second gearbox 330b. The components, structure, and operation of the second electric motor 324, and the described alternative configurations thereto, is the same or similar as described above for the second electric motor 224 in the FIG. 2 example.

In the FIG. 3 example, the second electric motor 324 is connected to the second gearbox 330b by the second disconnect link 326, which allows for rotational connection and disconnection of the second electric motor 324 and the second gearbox 330b in the manner described above for the second disconnect link 226 in the FIG. 2 example. The second motor output shaft 328 connects the second electric motor 324 to the second disconnect link 326. A second gearbox input shaft 332b connects the second gearbox 330b to the second disconnect link 326. As described above for the FIG. 2 example, it should be understood that, in alternate examples (not shown), the second disconnect link 326 may be omitted, and the second motor output shaft 328 may be connected to the second gearbox input shaft 332b so that they rotate in unison and cannot be rotationally disconnected. As described above for the FIG. 2 example, the second disconnect link 326 may be omitted and the first disconnect link 316 may be used.

The second disconnect link 326 is configured to move between an engaged position and a disengaged position. In the engaged position of the second disconnect link 326, the second disconnect link 326 transmits torque from the second motor output shaft 328 to the second gearbox input shaft 332b (or other torque receiving input structure of the second gearbox 330b). Thus, in the engaged position, rotation of the second motor output shaft 328 by the second electric motor 324 provides a second input torque to the second gearbox 330b. In the disengaged position of the second disconnect link 326, the second disconnect link 326 has disconnected the torque-transmitting connection of the second motor output shaft 328 and the second gearbox input shaft 332b so that they rotate independently of each other, and torque is not transmitted between the second motor output shaft 328 and the second gearbox input shaft 332b. Thus, the second disconnect link 326 moves between the engaged position in which the second motor output shaft 328 is connected to the second gearbox 330b so that rotation of the second motor output shaft 328 provides the second input torque to the second gearbox 330b, and the disengaged position in which the second motor output shaft 328 is rotationally disconnected from the second gearbox 330b so that rotation of the second motor output shaft 328 does not provide the second input torque to the second gearbox 330b. The components, structure, and operation of the second disconnect link 326, and the described alternative configurations thereto, is the same or similar as described above for the second disconnect link 226 in the FIG. 2 example. As described above for the FIG. 2 example, it is understood that the positions or locations of the first disconnect link 316 and/or the second disconnect link 326 may take alternate positions (e.g., inside the respective gearbox coupled with either the gearbox input shaft or the gearbox output shaft). As described for the FIG. 2 example, in one example (not shown) the first disconnect device 316 and the second disconnect link 326 may be omitted.

The second gearbox 330b includes the second gearbox input shaft 332b, a second gearbox output shaft 334b, and a second gear train 336b. The second gearbox 330b establishes a geared relationship of the second gearbox input shaft 332b and the second gearbox output shaft 334b (e.g., for gear reduction of the output of the second electric motor 324 so that the second gearbox output shaft 334b rotates in response to the second input torque. The second gearbox 330b receives the second input torque from the second electric motor 324 and causes rotation of the second gearbox output shaft 334b to provide the second gearbox output torque in response to the second input torque. The second gearbox 330b is connected, directly or indirectly (e.g., through the differential device, not shown), to the wheels of the second wheel pair 302c, 302d by the second gearbox output shaft 334b so that an output torque is applied to the second gearbox output shaft 334b by the second gear train 336b and is provided to one or both wheels of the second wheel pair 302c, 302d, for example, to cause motion of the vehicle 100. The components, structure, and operation of the second gearbox 330b, and the described alternative configurations thereto, is the same or similar as described above for the gearbox 230 in the FIG. 2 example, and/or the first gearbox 330a in the FIG. 3 example.

In the FIG. 3 example, the first inverter 312 and the first electric motor 314 are positioned and configured to provide the first motor input torque to drive or provide power to a wheel of the first wheel pair 302a, 302b positioned toward the front of the vehicle 100, and the second inverter 322 and the second electric motor 324 are positioned and configured to provide the second motor input torque to drive or provide power to a wheel of a second wheel pair 302c, 302d positioned toward the rear of the vehicle 100. In an alternate example (not shown), the first inverter 312 and the first electric motor 314 are positioned and configured to provide the first motor input torque to drive or provide power to a wheel of the second wheel pair 302c, 302d positioned toward the rear of the vehicle 100, and the second inverter 322 and the second electric motor 324 are positioned and configured to provide the second motor input torque to drive or provide power to a wheel of the first wheel pair 302a, 302b positioned toward the front of the vehicle 100.

The first drivetrain 310 and the second drivetrain 311 may be separately fused to allow disconnection of electric power to each of the first drivetrain 310 and the second drivetrain 311 independent of the other. In the FIG. 3 example, the first drivetrain 310 further includes a first electrical circuit 340 electrically connecting the first inverter 312 to the battery 109. The first electrical circuit 340 provides for the first inverter 312 to receive the direct current electrical power from the one or more batteries 109 (one battery 109 shown) through the first electrical circuit 340. In one example, the first electrical circuit 340 includes a battery cable, or other electrical cable, configured to transmit the direct current electrical power from the one or more batteries 109 to the first inverter 312. In one example, the first electrical circuit 340 includes a first fuse 341 positioned along the first electrical circuit 340 between the battery 109 and the first inverter 312. The first fuse 341 is configured to include a first state in which the first fuse 341 allows the flow of the direct current electrical power between the battery 109 and the first inverter 312 (or between the first inverter 312 and the battery 109 in a regenerative braking condition described above, or other regenerative condition of the vehicle 100), and a second state in which the first fuse 341 prevents the flow of the direct current electrical power between the battery 109 and the first inverter 312. In one example of the second state of the first fuse 341, the first fuse 341 is “tripped” or “blown” on one or more predetermined conditions, for example an electrical short on an electrical power input to the first inverter 312. In one example of the first fuse 341, the first fuse 341 is an electrical fuse or an electrical breaker of conventional design in electric vehicle direct current electrical power applications. The first fuse 341 may enter the second state (e.g., “tripped” or “blown”) passively, for example, by a physical change induced in the first fuse 341 by operating conditions (e.g., breaking or melting due to high temperature), or may enter the second state as a result of a command that actively causes the first fuse 341 to enter the second state.

In the FIG. 3 example, the second drivetrain 311 further includes a second electrical circuit 344 electrically connecting the second inverter 322 to the battery 109. In the FIG. 3 example, the second electrical circuit 344 is independent of the first electrical circuit 340 (i.e., the second electrical circuit 344 is a separate electrical circuit and not connected to, or in electrical communication with, the first electrical circuit 340 as shown in FIG. 3). The second electrical circuit 344 provides for the second inverter 322 to receive the direct current electrical power from the one or more batteries 109 (one battery 109 shown) through the second electrical circuit 344. In one example, the second electrical circuit 344 includes a battery cable, or other electrical cable, configured to transmit the direct electrical power from the one or more batteries 109 to the second inverter 322 (or between the second inverter 322 and the battery 109 in a regenerative braking condition described above, or other regenerative condition of the vehicle 100). In one example, the second electrical circuit 344 includes a second fuse 345 positioned along the second electrical circuit 344 between the battery 109 and the second inverter 322. The second fuse 345 is configured to include a first state in which the second fuse 345 allows the flow of the direct current electrical power between the battery 109 and the second inverter 322 (or between the second inverter 322 and the battery 109 in a regenerative braking condition described above), and a second state in which the second fuse 345 prevents the flow of the direct current electrical power between the battery 109 and the second inverter 322. In one example of the second state of the second fuse 345, the second fuse 345 is “tripped” or “blown” on one or more predetermined conditions, for example an electrical short on an electrical power input to the second inverter 322. In one example of the second fuse 345, the second fuse 345 is an electrical fuse or an electrical breaker of conventional design in electric vehicle direct current electrical power applications. The second fuse 345 may enter the second state (e.g., “tripped” or “blown”) passively, for example, by a physical change induced in the second fuse 345 by operating conditions (e.g., breaking or melting due to high temperature), or may enter the second state as a result of a command that actively causes the second fuse 345 to enter the second state.

In the FIG. 3 example, the architecture of the first drivetrain 310 including the first electrical circuit 340 and the first fuse 341, and second drivetrain 311 including the second electrical circuit 344 and the second fuse 345 independent of the first electrical circuit 340, provides for the first drivetrain 310 to be fused separately from the second drivetrain 311. In other words, the first drivetrain 310 is configured to be separately and independently powered (i.e., by battery 109) and/or controlled (i.e., by control system 108, control system 308 for example, discussed further below) with respect to the second drivetrain 311. This provides advantages, flexibility, efficiencies, fault tolerance, and/or redundant capabilities in independently providing the direct current electrical power to the first drivetrain 310 and the second drivetrain 311, and operation of the respective inverters and motors as discussed further below.

As similarly described for the FIG. 2 example of the first inverter 212 and the first electric motor 214, and the second inverter 222 and the second electric motor 224, the first inverter 312, the first electric motor 314, the second inverter 322, and the second electric motor 324 may be implemented using different designs and/or motor topologies in order to optimize the first electric motor 314 and the second electric motor 324 for different operating conditions. In the FIG. 3 example, the first inverter 312 and the first electric motor 314, and the second inverter 322 and the second electric motor 324 may, individually and/or collectively, be optimized to operate in exclusive or overlapping operating speed ranges and/or torque ranges.

As one example, the first electric motor 314 is optimized for operation in a first operating speed range, and the second electric motor 324 is optimized for operation in a second operating speed range, wherein at least part of the second operating speed range is higher than a maximum operating speed of the first operating speed range. In another example, the first electric motor 314 is optimized for operation in a first torque range, and the second electric motor 324 is optimized for operation in a second torque range, wherein at least part of the first torque range is higher than a maximum operating torque of the second torque range. It is understood that in an alternate example, the described operating ranges and the torque ranges may be reversed respecting the first electric motor 314 and the second electric motor 324 (i.e., the first electric motor 314 may be optimized for the second operating speed range and the second torque range, and the second electric motor 324 may be optimized for the first operating speed range and the first torque range).

In a similar manner described for the FIG. 2 example, in the FIG. 3 example, in order to achieve different operating characteristics, the first electric motor 314 and the second electric motor 324 may use different motor architectures. These may be based on known designs, such as interior permanent magnet designs, surface mount permanent magnet designs, axial flux designs, and radial flux designs, and by using either of thick laminations with high permeability or thin laminations with low core loss. In one example of the first electric motor 314 and the second electric motor 324, each motor is configured as a three-phase induction motor described above. As described above for the FIG. 2 example, the first electric motor 314 and/or the second electric motor 324 may be configured having 2, 4, 6, or 8 pole, or alternate pole, stator configurations.

Referring to the FIGS. 3-5 examples, the propulsion system 304 includes a control system 308 (e.g., control system 108) in communication with the first drivetrain 310 and the second drivetrain 311 components as described and illustrated herein. The components and structure of the control system 308, and the described alternative configurations thereto, is the same or similar as described above for the control system 108 in the FIG. 2 example (as applied to the first drivetrain 310 and the second drivetrain 311), and as further described and illustrated below. Although a single or one of the control system 308 is illustrated in FIGS. 3-5, it is understood that more than one of the control system 308 may be used that are separate and independent from one another. For example, a first control system may be in communication with the first drivetrain 310, and a separate and/or independent second control system may be in communication with the second drivetrain 311 for independent control of the first drivetrain 310 and the second drivetrain 311. In one example the separate and/or independent first control system and the second control system may be in communication with a central computer or central controls system (e.g., control system 108) to monitor and determine the activity or operation of the independently controlled first drivetrain 310 and the second drivetrain 311.

In the examples shown in FIGS. 3-5, the control system 308 is configured to alternate or switch the propulsion system 304 of the vehicle 100 between a first drivetrain operating mode, a second drivetrain operating mode, and a third drivetrain operating mode, based on operating characteristics of the vehicle 100, such as a vehicle speed of the vehicle 100, an operating speed of the first electric motor 314, an operating speed of the second electric motor 324, an operating torque of the first electric motor 314, and/or an operating torque of the second electric motor 324.

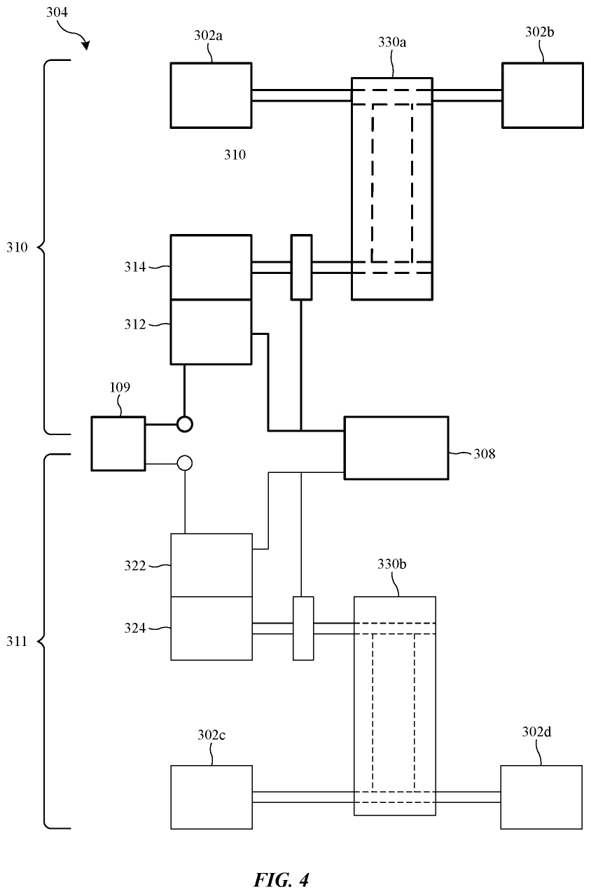

As shown in the FIG. 4 example (the first drivetrain 310 shown in darker lines), in the first drivetrain operating mode, the first electric motor 314 provides the first input torque to the first gearbox 330a, the second electric motor 324 does not provide the second input torque to the second gearbox 330b, and the first disconnect link 316 is in the engaged position (in the illustrated example where the first drivetrain 310 includes the first disconnect link 316). In one example when operating in the first drivetrain operating mode, the control system 308 is configured to move the second disconnect link 326 to the disengaged position to reduce, or eliminate, the electromagnetic drag torque by the second electric motor 324 (e.g., negative drag torque). The option to move the second disconnect link 326 to the disengaged position to reduce or eliminate the electromagnetic drag torque by the second electric motor 324 provides advantages, flexibility, fault tolerance, redundant capabilities, and/or efficiencies in allowing the differently configured first drivetrain 310 (i.e., the above-described optimized pairing of the first inverter 312 and the first electric motor 314) to more efficiently operate to maintain mobility of the vehicle 100 in the event of a fault or failure in the second drivetrain 311 as further discussed below. In an alternate example of the first drivetrain operating mode, the second disconnect link 326 is not moved to the disengaged position.

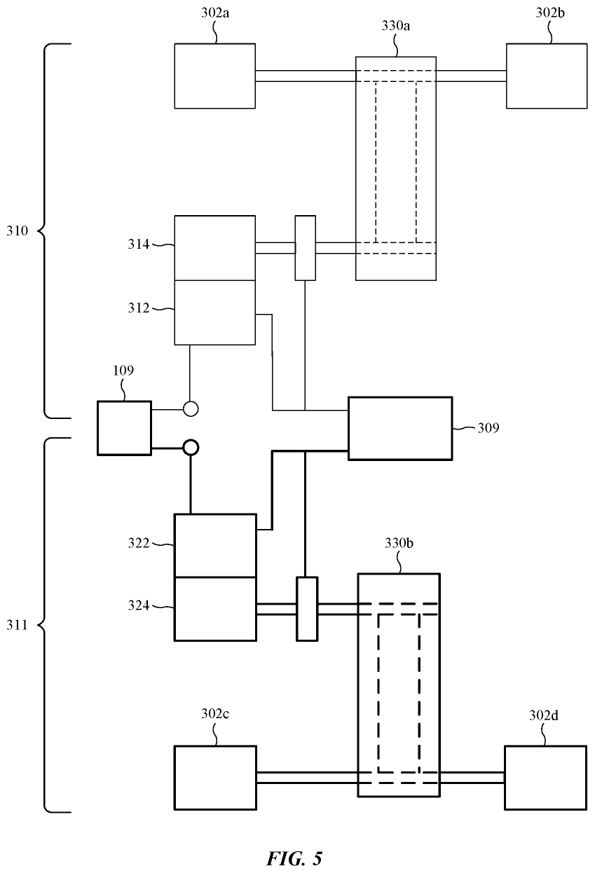

As shown in the FIG. 5 example (the second drivetrain 311 shown in darker lines), in the second drivetrain operating mode, the first electric motor 314 does not provide the first input torque to the first gearbox 330a, the second electric motor 324 provides the second input torque to the second gearbox 330b, and the second disconnect link 326 is positioned in the engaged position. In one example when operating in the second drivetrain operating mode, the control system 308 is configured to move the first disconnect link 316 to the disengaged position to reduce, or eliminate, the electromagnetic drag torque by first electric motor 314 (e.g., negative drag torque). The option to move the first disconnect link 316 to the disengaged position to reduce or eliminate the electromagnetic drag torque by the first electric motor 314 provides advantages, flexibility, fault tolerance, redundant capabilities, and/or efficiencies in allowing the differently configured second drivetrain 311 (i.e., the above-described optimized pairing of the second inverter 322 and the second electric motor 324) to more efficiently operate to maintain mobility of the vehicle 100 in the event of a fault or failure in the first drivetrain 310 as further discussed below. In an alternate example of the second drivetrain operating mode, the first disconnect link 316 is not moved to the disengaged position.

As generally shown in the FIG. 3 example, in the third drivetrain operating mode, the first electric motor 314 provides the first motor input torque to the first gearbox 330a generating the first gearbox output torque, and the second electric motor 324 provides the second motor input torque to the second gearbox 330b generating the second gearbox output torque. In the example, the first disconnect link 316 is in the engaged position, and second disconnect link 326 is in the engaged position. As described above for the FIG. 2 example, the propulsion system 304, for example by the control system 308, may include or implement an optimal efficiency torque split control strategy to, for example, monitor, change, adjust, and/or balance the torque command between the first drivetrain 310 (i.e., the first inverter 312 and the first electric motor 314) and the second drivetrain 311 (i.e., the second inverter 322 and the second electric motor 324) to provide partial first motor input torque to the first gearbox 330a and provide partial second motor input torque to the second gearbox 330b to optimize the efficiency of the propulsion system 304 to, for example, maximize the range of the vehicle 100.

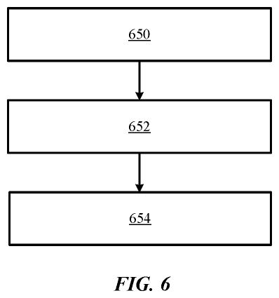

Referring to the FIG. 6 example, in one example of propulsion system 104, for example the propulsion system 304, the control system 308 is configured to detect a fault at 650 in first drivetrain 310, the second drivetrain 311, or combinations thereof, determine whether the fault is in the first drivetrain 310 or the second drivetrain 311 at 652, determine a response to the fault at 654, and execute the response determined to the first drivetrain 310, the second drivetrain 311, or combinations thereof, as described further below.

In one example, the detection of the fault is determined by one or more sensors (not shown) of the sensing system 107 and communicated with the control system 308. In one example, one or more sensors of the sensing system 107 are configured to transmit or send output signals to, for example, the control system 308 that are compared by the control system 308 to predetermined values or states (e.g., values, data, or states of operation that are indicative of values, or ranges of values, or states of operation predetermined to be normal or acceptable for the vehicle system or vehicle 100 that are stored in a memory storage device). If the comparison determines that one or more of the sensor output signals is outside of the predetermined value or an in incorrect state of operation, the control system 308 is configured to determine or identify that a fault or failure condition exists. The control system 308 is configured to further determine or identify the particular fault and/or whether the fault occurred in the first drivetrain 310 or the second drivetrain by, for example, identifying whether the sensor output signal determined to be a fault, or in a failure condition, is from a sensor or component in the first drivetrain 310 or the second drivetrain 311.

In one example of the propulsion system 304 and the control system 308, the first inverter 312 and the first electric motor 314 are configured to be optimized in the first operating speed range and the first torque range as described above (i.e., at least part of the second operating speed range is higher than the maximum operating speed range of the first operating speed range, and at least part of the first torque range is higher than the maximum operating torque of the second torque range). In other words, in the below described examples, the first inverter 312 and the first electric motor 314 are configured to be optimized for use for lower vehicle speeds and higher electric motor torque than the second inverter 322 and the second electric motor 324 that are configured to be optimized for use for higher vehicle speeds and lower electric motor torque. As described above, in an alternate example, it is understood that the speed range and the torque range for the first drivetrain 310 and the second drivetrain 311 can be reversed. In other words, the second drivetrain 311 (i.e., the second inverter 322 and the second electric motor 324) may be optimized for use for lower vehicle speeds and higher electric motor torque than the first drivetrain 310 (i.e., the first inverter 312 and the first electric motor 314).

Due to the differently configured and optimized designs of the first drivetrain 310 and the second drivetrain 311 as described, and the separately fused first drivetrain 310 and the second drivetrain 311 (e.g., by the first electrical circuit 340 and the second electrical circuit 344), on detection of the fault at 650 in one of the first drivetrain 310 or the second drivetrain 311, the control system 308 is configured to exclusively operate the other of the first drivetrain 310 (e.g., operate the second drivetrain 311, FIG. 5, on a fault in the first drivetrain 310), or the second drivetrain 311 (e.g., operate the first drivetrain 310, FIG. 4, on a fault in the second drivetrain 311) to maintain the mobility of the vehicle 100. Alternately, the control system 308 is configured to operate the first drivetrain 310 and/or the second drivetrain 311 through one of the responses determined at 654 to the fault detected described further below, to maintain operation of the propulsion system 304 (or the propulsion system 104 example) to maintain mobility of the vehicle 100. The examples described below provide added flexibility, fault tolerance, and redundancy capabilities of the propulsion system 304, and the vehicle 100.

Referring generally to the FIGS. 3 and 6 examples, the propulsion system 304 and the first drivetrain 310 and the second drivetrain 311 are shown and described above. In one example of operation, the control system 308 is configured to operate in the third drivetrain operating mode (i.e., the first electric motor 314 provides first motor input torque to the first gearbox 330a and the second electric motor 324 provides second motor input torque to the second gearbox 330b). As best seen in FIG. 6, on a detection by the control system 308 of the fault at 650, the control system 308 is configured to determine or identify at 652 whether the fault occurred in the first drivetrain 310 or the second drivetrain 311.

Referring to the FIGS. 4 and 6 example, on the determination that the fault detected is in the second drivetrain 311 at 652, the control system 308 determines a response at 654. In one example of the fault detected in the second drivetrain 311 at 652, the control system 308 is configured to alternate or switch the propulsion system 304 to the first drivetrain operating mode (i.e., FIG. 4, the first inverter 312 and the first electric motor 314 provide the first motor input torque to the first gearbox 330a and the second inverter 322 and the second electric motor 324 do not provide the second motor input torque to the second gearbox 330b). In one example, the control system 308 is configured to move the second disconnect link 326 to the disengaged position to reduce, or eliminate, the electromagnetic drag torque by the second electric motor 324 in the manner described above. The example of the control system 308 moving the second disconnect link 326 to the disengaged position is advantageous in the example wherein the first inverter 312 and the first electric motor 314 are optimized in the first operating speed range and the first torque range, and the second inverter 322 and the second electric motor 324 are optimized in the second operating speed range and the second operating torque range as described above. In an alternate example, the second disconnect link 326 is not moved to the disengaged position.

Referring to the FIGS. 5 and 6 example, on the determination that the fault detected is in the first drivetrain 310 at 652, the control system 308 determines a response at 654. In one example of the fault detected in the first drivetrain 310, the control system 308 is configured to alternate or switch the propulsion system 304 to the second drivetrain operating mode (i.e., the first inverter 312 and the first electric motor 314 do not provide the first motor input torque to the first gearbox 330a and the second inverter 322 and the second electric motor 324 do provide the second motor input torque to the second gearbox 330b). In the example described wherein the first inverter 312 and the first electric motor 314 are optimized in the first operating speed range and the first torque range, and the second inverter 322 and the second electric motor 324 are optimized in the second operating speed range and the second operating torque range, on determination of the fault in the first drivetrain 310, it may not be necessary for the control system 308 to move the first disconnect link 316 to the disengaged position to reduce, or eliminate, the electromagnetic drag by the first electric motor 314. In other words, in this example, the second drivetrain 311 and the second electric motor 324 may have sufficient power, speed range, and/or torque range to continue propulsion of the vehicle 100 despite electromagnetic drag by the first electric motor 314 (and the first drivetrain 310 in general). This equally applies in an alternate configuration of the first drivetrain 310 where the first disconnect link 316 is omitted as described above. In an alternate example, the control system 308 is configured to move the first disconnect link 316 to the disengaged position to reduce, or eliminate, the electromagnetic drag torque by the first electric motor 314 in the manner described above. Equally, in one example, on determination of the fault in the second drivetrain 311, it may not be necessary for the control system 308 to move the second disconnect link 326 to the disengaged position to reduce, or eliminate, the electromagnetic drag by the second electric motor 324 (or the second drivetrain 311 in general) to continue propulsion of the vehicle 100 as described above. This equally applies in an alternate configuration of the second drivetrain 311 where the second disconnect link 326 is omitted as described above.

Referring to the FIGS. 6-8 examples, in one example of propulsion system 304, and the control system 308 example, in the detection of the fault at 650 by the control system 308, the fault may be a single switch short fault 760, a single switch open fault 762, a more than one switch short fault 764, or a six switch open fault 766, or combinations thereof. In one example of the single switch short fault 760, a single electrical switch of the first inverter 312 or the second inverter 322 experiences an electrical short (e.g., a single electrical switch of the inverter is stuck in a closed state) which affects the three-phase alternating current electrical power supplied to the first electric motor 314 or the second electric motor 324, respectively. In one example of the single switch open fault 762, a single electrical switch of the first inverter 312 or the second inverter 322 experiences an open condition (e.g., a single electrical switch of the inverter is stuck in an open state) which affects the three-phase alternating current electrical power to the first electric motor 314 or the second electric motor 324, respectively. In one example of the more than one switch short fault 764, more than one of the electrical switches of the first inverter 312 or the second inverter 322 experiences an electrical short (e.g., more than one of the electrical switches of the inverter is stuck in a closed state) which affects the three-phase alternating current electrical power supplied to the first electric motor 314 or the second electric motor 324, respectively. In one example of the six switch open fault 766, in an example of the first inverter 312 and the second inverter 322 having three pairs of switches as described above (i.e., a total of six electrical switches), all six of the electrical switches experience an open condition (e.g., all six of the electrical switches of the inverter are stuck in an open state) which prevents the flow of the three-phase alternating current electrical power to the first electric motor 314 or the second electric motor 324, respectively.

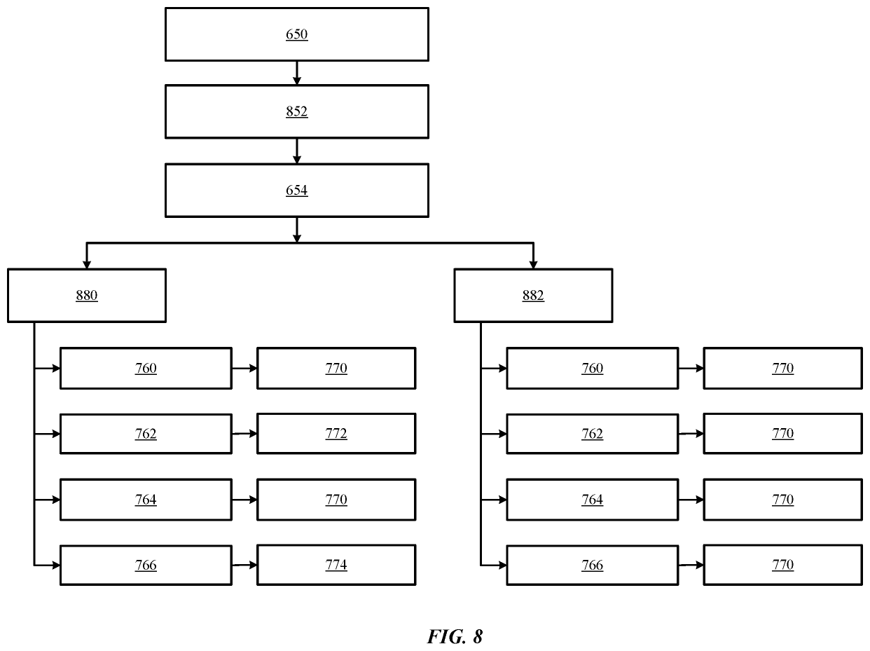

As explained above, it is understood that the first inverter 312 and/or the second inverter 322 may be of alternate designs or configurations (e.g., fewer number of electrical switch pairs, or a greater number of electrical switch pairs) which may change or alter the fault detected by the control system 308. The type of fault detected at 650, the response determined or associated with the fault detected at 654, and execution of the response determined with the fault detected, may be predetermined and stored in the control system 308, for example in a memory storage device, shown in FIG. 8 and further discussed below. It is understood that the fault detected at 650 by the control system 308, and the response determined at 654 to the fault detected at 650, may vary from the single switch short fault 760, the single switch open fault 762, the more than one switch short fault 764, and the six switch open fault 766 described depending on the inverters, the electric motors, the disconnect links, the gearboxes, and/or other components and operations of the first drivetrain 310 and the second drivetrain 311 as known by those persons skilled in the art. In an alternate example, the response determined at 654 and executed may be hardwired, i.e., does not rely on microcontrollers, memory devices, or other components in the control system 308 (e.g., if there is a failure in the control system 308 and/or memory storage devices in the control system 308). In one example, a separate electrical circuit may be used to implement or execute a fault response on the detection of a failure and/or irregularity outside of normal operating conditions in the first drivetrain 310 or the second drivetrain 311. In this alternate example, the response determined at 654 and executed may be any one of, or a combination of, the responses determined at 654 and executed as described herein.

In one example of the propulsion system 304 and the control system 308, the detection of the fault (or multiple faults) at 650 is made or detected by one or more sensors described above for the sensing system 107 in electronic communication with the control system 108 (for example, control system 308).

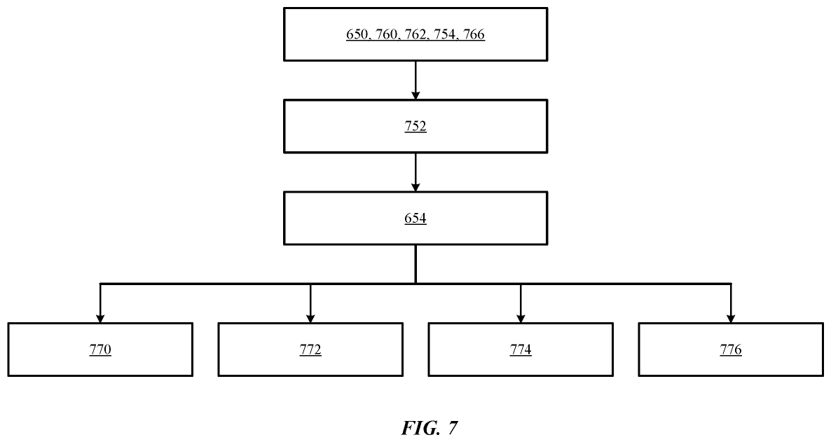

Referring to FIGS. 7-8, in one example, the response determined at 654 by the control system 308 is a three-phase short condition response 770, a six switch open condition response 772, a no reaction response 774, or combinations thereof. The control system 308 is configured to implement one or more of these responses in the first drivetrain 310 (i.e., the first inverter 312, the first electric motor 314, and the first disconnect link 316), the second drivetrain 311 (i.e., the second inverter 322, the second electric motor 324, and the second disconnect link 326), or combinations thereof, in the manners described further below. In one example described further below for FIG. 7, for the fault detected at 650 in the second drivetrain at 752, the response determined at 654 is for the control system 308 to implement a disengage second disconnect link condition response at 776 (i.e. the control system 308 moves the second disconnect link 326 to the disengaged position in a manner described above).

Referring to the FIG. 7 (fault detected in the second drivetrain 311) and FIG. 8 (fault detected in the first drivetrain 310) examples, in one example of the three-phase short condition response 770, the control system 308 is configured to implement, or place, the first electric motor 314 and/or the second electric motor 324 in the three-phase short condition response 770. In one example shown in FIG. 8, on detection of the fault at 650 in the first drivetrain 310 at 852 by the control system 308, the control system 308 is configured to place the first electric motor 314 in the three-phase short condition response 770 wherein all three pairs of the first electric motor 314 stator wire coils (e.g., two wire coils for each alternating current phase) are simultaneous and continuously energized or provided the respective phase of the alternating current electrical power from the first inverter 312 (described in the two pole electric motor configuration for simplicity only). In one example, the control system 308 is configured to short, or close, all three of the first inverter 312 switch pairs (i.e., shorting all three phases of the alternating current electrical power together), thereby providing a continuous supply of the alternating current electrical power in all three phases to the first electric motor 314. In an alternate example shown in FIG. 7, on detection of the fault at 650 in the second drivetrain 311 at 752, the control system 308 is configured to implement the three-phase short condition response 770 in the second electric motor 324 in the manner described.

It has been determined that implementing a three-phase short condition response 770 creates a defined torque characteristic of the three-phase shorted electric motor (e.g., the first electric motor 314 in the FIG. 8 example) relative to the rotation speed of the electric motor. For example, it has been determined that in the three-phase short condition response 770, the first electric motor 314 exhibits consistently relatively low electromagnetic drag torque over a broad range of vehicle speeds above a vehicle base speed, and an increasingly higher electromagnetic drag torque below the vehicle base speed. In one example, the vehicle base speed is 34.3 miles per hour (mph). The vehicle base speed may be predetermined and stored in a memory storage device in the control system 108 shown in FIG. 8 and described further below. It is understood that that vehicle base speed may be a lower speed, or a higher speed, than the example 34.3 mph depending on the application, the configuration of the first drivetrain 310, the configuration of the second drivetrain 311, the first electric motor 314, the second electric motor 324, the operating speed range of the first electric motor 314, the operating speed range of the second electric motor 324, the torque range of the first electric motor 314, the torque range of the second electric motor 324, and/or other vehicle 100 characteristics as known by those persons skilled in the art. It is understood that the points or ranges where the first electric motor 314 and/or the second electric motor 324 exhibit consistently relatively low electromagnetic drag torque and an increasingly higher electromagnetic drag torque may vary depending on the respective configuration of the first electric motor 314 and the second electric motor 324, the respective operating speed range of the first electric motor 314 and the second electric motor 324, the respective torque range of the first electric motor 314 and the second electric motor 324, and/or other characteristics known by those persons skilled in the art.

Still using the FIG. 8 example of the detected fault at 650 in first drivetrain 310 at 852 as an example, in one example, the control system 308 is configured to implement, or place, the first electric motor 314 in a six switch open condition response 772. In the six switch open condition response 772, at least one of the three pairs of the switches of the first inverter 312 is placed in an open state (i.e., the open switch of the first inverter 312 does not allow the particular phase of the alternating current electrical power to transfer from the first inverter 312 to the corresponding stator wire coil of the first electric motor 314). In another example, more than one pair of the switches of the first inverter 312 is placed in an open condition. In another example, all three pairs of the switches (i.e., all six switches) of the first inverter 312 are placed in an open condition. In an alternate example shown in FIG. 7, on detection of the fault at 650 in the second drivetrain 311 at 752, the control system 308 is configured to implement the six switch open condition response 772 in the second electric motor 324 in the manner described.

It has been determined that implementing the six switch open condition response 772 creates a defined torque characteristic of the three-phase electric motor (e.g., the first electric motor 314 in the example) relative to the rotation speed of the electric motor. For example, it has been determined that in the six switch open condition response 772, the first electric motor 314 exhibits consistently no electromagnetic drag torque over a broad range of lower vehicle speeds and an increasingly higher electromagnetic drag torque at and above a relatively high vehicle speed. In one example, use of the six switch open condition response 772 on the first drivetrain 310 (i.e., the first electric motor 314) is more efficient respecting the level of electromagnetic drag torque, and thus is the preferred, but not exclusive, condition response, at lower vehicle speeds. It is understood that the points or ranges where the first electric motor 314 and/or the second electric motor 324 exhibit consistently no, or relatively low, electromagnetic drag torque and an increasingly higher electromagnetic drag torque may vary depending on the respective configuration of the first electric motor 314 and the second electric motor 324, the respective operating speed range of the first electric motor 314 and the second electric motor 324, the respective torque range of the first electric motor 314 and the second electric motor 324, and/or other characteristics known by those persons skilled in the art.

Referring to the FIG. 8 example, in one example, on detection of the fault at 650 in the first drivetrain 310 by the control system 308 at 852, the control system 308 is configured to implement the no reaction response 774 (i.e., no responsive action or no corrective action is taken by the control system 308) respecting the first drivetrain 310 (i.e., the first inverter 312 or the first electric motor 314). In other words, although a fault is detected at 650 in the first drivetrain 310 at 852, the response determined by the control system 308 is to not implement a response condition or reaction by the control system 308 in the first drivetrain 310. In an alternate example in FIG. 7, on detection of the fault at 650 in the second drivetrain 311 at 752, the control system 308 is configured to implement the no reaction response 774 in the second drivetrain 311.

Referring to the FIG. 7 example, in one example, on detection of the fault at 650 in the second drivetrain 311 at 752 by the control system 308, the control system 308 is configured to implement the disengage second disconnect link condition response at 776 (i.e. the control system 308 moves the second disconnect link 326 to the disengaged position in the manner described above).

Referring to FIG. 7, an example of the control system detecting the fault at 650 in the second drivetrain 311 at 752, and examples of the control system 308 determining and implementing a response at 654 is illustrated. In the example, the propulsion system 304 is configured to be in either of the second drivetrain operating mode or the third drivetrain operating mode as described above. In the example, the first inverter 312 and the first electric motor 314 are configured to be optimized in the first operating speed range and the first torque range and the second inverter 322 and the second electric motor 324 are optimized in the second operating speed range and the second operating torque range as described above. In the example, the control system 308 is configured to detect the fault (or other fault or failure) at 650 in the second drivetrain 311 at 752, and the response is determined at 654 based on the fault detected.

In one example, the control system 308 is configured to implement the three-phase short condition response 770 in the second drivetrain 311 (e.g., the second electric motor 324) in the manner described above. In another example, the control system 308 is configured to implement the six switch open condition response 772 in the second drivetrain 311 (e.g., the second electric motor 324) in the manner described above. In one example, the determination whether the control system 308 implements the three-phase short condition response 770 or the six switch open condition response 772 takes into consideration one or more factors detected or determined including the fault detected as described above, the vehicle speed detected, the configuration of the second drivetrain 311, and/or other vehicle characteristics described herein. In another example, the control system 308 is configured to implement the no reaction response 774 in the second drivetrain 311 in the manner described above. In another example, the control system 308 is configured to implement the disengage second disconnect condition response 776 in the second drivetrain 311 in the manner described above.

Referring to FIG. 8, an example of the control system 308 detecting the fault at 650 in the first drivetrain 310 at 852 and examples of the control system 308 determining and implementing a response at 654 is illustrated. In the example, the propulsion system 304 is configured to be in either of the first drivetrain operating mode or the third drivetrain operating mode as described above. In the example, the first inverter 312 and the first electric motor 314 are configured to be optimized in the first operating speed range and the first torque range and the second inverter 322 and the second electric motor 324 are optimized in the second operating speed range and the second operating torque range as described above. In the example, the control system 308 is configured to detect the fault (or other fault or failure) at 650 in the first drivetrain 310 at 852 and the response is determined and implemented at 654 based on the fault detected, the vehicle speed detected, the configuration of the first drivetrain 310, and/or other vehicle characteristics described below.

In the FIG. 8 example, on the detection of the fault in the first drivetrain 310 at 852 the control system 308 is configured to detect or determine the vehicle speed (not shown). In one example, the response determined and implemented at 654 is based at least in part on the vehicle speed detected, for example by one or more sensors in sensing system 107 in communication with the control system 308 as described above. As described above for the three-phase short condition response 770, use of the three-phase short condition response 770 on the first drivetrain 310 (i.e., the first electric motor 314) is more efficient respecting the level of electromagnetic drag torque, and thus is the preferred, but not exclusive, condition response, when the vehicle speed is at relatively higher vehicle speeds. In order to improve the efficiency or minimize the electromagnetic drag torque, and the determining of when to implement the three-phase short condition response 770, a vehicle base speed is predetermined based at least in part on evaluation of the three-phase short condition response 770 electromagnetic drag torque versus the vehicle speed detected. In one example of the first drivetrain 310 having an optimized configuration described above, the vehicle base speed is predetermined at 34.3 miles per hour (mph). It is understood that the vehicle base speed may be a value lower or higher as described above. In one example, the vehicle base speed that is predetermined is stored in a memory storage device in the control system 308.

In the FIG. 8 example, a comparison or calculation is made between the vehicle speed detected and the vehicle base speed predetermined and stored in the memory storage device described above. In one example, the control system 108, through a processor disclosed further below, is configured to make a comparison or calculation between the vehicle speed detected and the vehicle base speed and determine or calculate whether the vehicle speed detected is below the vehicle base speed at 880 or whether the vehicle speed detected is above the vehicle base speed at 882. It is understood that alternate, or additional, vehicle characteristics may be detected or determined, and used at least in part to determine the response at 654. It is further understood that the detection of the vehicle speed and the determination of whether the vehicle speed detected is below the vehicle base speed at 880 or above the vehicle base speed at 882 may be omitted.

In the FIG. 8 example, on detection by the control system 308 of the fault in the first drivetrain 310 at 852, and on the determination by the control system 308 of the vehicle speed detected is below the vehicle base speed at 880, in one example, on the detection by the control system 308 that the fault is the single switch short fault 760, the control system 308 is configured to implement the three-phase short condition response 770 in the first inverter 312 and the first electric motor 314 in the manner described above.

In the FIG. 8 example, on detection by the control system 308 of the fault in the first drivetrain 310 at 852, and on the determination by the control system 308 of the vehicle speed detected is below the vehicle base speed at 880, in one example, on the detection by the control system 308 that the fault is the single switch open fault 762, the control system 308 is configured to implement the six switch open condition response 772 in the first inverter 312 and the first electric motor 314 in the manner described above.

In the FIG. 8 example, on detection by the control system 308 of the fault in the first drivetrain 310 at 852, and on the determination by the control system 308 of the vehicle speed detected is below the vehicle base speed at 880, in one example, on the detection by the control system 308 that the fault is the more than one switch short fault 764, the control system 308 is configured to implement the three-phase short condition response 770 in the first inverter 312 and the first electric motor 314 in the manner described above.

In the FIG. 8 example, on detection by the control system 308 of the fault in the first drivetrain 310 at 852, and on the determination by the control system 308 of the vehicle speed detected is below the vehicle base speed at 880, in one example, on the detection by the control system 308 that the fault is the six switch open fault 766, the control system 308 is configured to implement the no reaction response 774 in the first inverter 312 and the first electric motor 314 in the manner described above.

In the FIG. 8 example, on detection by the control system 308 of the fault in the first drivetrain 310 at 852, on the determination by the control system 308 of the vehicle speed detected is above the vehicle base speed at 882, in one example, on the detection by the control system 308 that the fault is the single switch short fault 760, the control system 308 is configured to implement the three-phase short condition response 770 in the first inverter 312 and the first electric motor 314 in the manner described above.

In the FIG. 8 example, on detection by the control system 308 of the fault in the first drivetrain 310 at 852, and on the determination by the control system 308 of the vehicle speed detected is above the vehicle base speed at 882, in one example, on the detection by the control system 308 that the fault is the single switch open fault 762, the control system 308 is configured to implement the three-phase short condition response 770 in the first inverter 312 and the first electric motor 314 in the manner described above. In one example, when the fault detected at 650 is the single switch open fault 762, and the vehicle speed detected is above the vehicle base speed at 882, a hardware circuit (not shown) in the first inverter 312 (or the control system 308), is configured to allow the control system 308 to implement the three-phase short condition response 770 using the residual motion of one or both wheels of the first wheel pair 302a, 302b, and/or the first electric motor 314 (e.g., rectifying off the first electric motor 314).

In the FIG. 8 example, on detection by the control system 308 of the fault in the first drivetrain 310 at 852, and on the determination by the control system 308 of the vehicle speed detected is above the vehicle base speed at 882, in one example, on the detection by the control system 308 that the fault is the more than one switch short fault 764, the control system 308 is configured to implement the three-phase short condition response 770 in the first inverter 312 and the first electric motor 314 in the manner described above.

In the FIG. 8 example, on detection by the control system 308 of the fault in the first drivetrain 310 at 852, and on the determination by the control system 308 of the vehicle speed detected is above the vehicle base speed at 882, in one example, on the detection by the control system that the fault is the six switch open fault 766, the control system 308 is configured to implement the three-phase short condition response 770 in the first inverter 312 and the first electric motor 314 in the manner described above. In one example, when the fault detected at 650 is the six switch open fault 766, and the vehicle speed detected is above the vehicle base speed at 882, a hardware circuit (not shown) in the first inverter 312 (or the control system 308), is configured to allow the control system 308 to implement the three-phase short condition response 770 using the residual motion of one or both of the wheels of the first wheel pair 302a, 302b, and/or the first electric motor 314 (e.g., rectifying off the first electric motor 314).

In one alternate example of FIG. 8, wherein the control system 308 is configured to detect the fault at 650, and the fault is determined to be in the first drivetrain 310 at 852, and the detection of the vehicle speed is not used to determine the response at 654 (i.e., at 880 or 882), wherein the fault detected is the single switch short fault 760, the more than one switch short fault 764, or combinations thereof, the control system 308 is configured to implement the three-phase short condition response 770 to the fault.

In one alternate example of FIG. 8, wherein the control system 308 is configured to detect the fault at 650, and the fault is determined to be in the first drivetrain 310 at 852, and the detection of the vehicle speed is not used to determine the response at 654 (i.e., at 880 or 882), wherein the fault detected is the single switch open fault 762 or the six switch open fault 766, the control system 308 is configured to implement one of the six switch open condition response 772, the three-phase short condition response 770, or the no reaction response 774 to the fault.

Although the FIG. 8 examples are described pertaining to the fault detected in the first drivetrain at 852 and the response associated as described, it is understood that one or more of the FIG. 8 examples described may be implemented by the control system 308 when the fault detected at 650 is in the second drivetrain 311 at 752.

In the FIG. 8 example, it is understood that the detection of the vehicle speed and/or the determining whether the vehicle speed detected is below the vehicle base speed at 880 or above the vehicle base speed at 882 may take place at a different time or sequence than as illustrated and described. For example, the determination of the vehicle speed and the determination whether the vehicle speed is below the vehicle base speed at 880, or above the vehicle base speed at 882, may occur prior to detection of the fault at 650 or prior to the determining whether the fault detected is in the first drivetrain 310 at 852.

Although the detection of the fault at 650 was described and illustrated as applicable to detection in the first drivetrain 310, the second drivetrain 311, or combinations thereof, at 652 (e.g., the all-wheel-drive or four-wheel-drive configurations in FIGS. 3 and 6-8) and the responses thereto, it is understood that the detection of the fault at 650 and the responses at 654 described herein are also applicable to the propulsion system 104 described and illustrated in FIG. 2 (i.e., in a two-wheel drive configuration of vehicle 100).

Referring to the FIGS. 2 and 6 example, in one example, following the detection of the fault (i.e., at 650), the control system (not shown in FIG. 2) determines whether the fault detected is in the first inverter 212 and/or the first electric motor 214 pair, or in the second inverter 222 and/or the second electric motor 224 pair. The control system is then configured to determine the response at 654 and implement the response in one or more of the manners described for the all-wheel drive vehicle configuration illustrated and described in FIGS. 3 and 6-8.

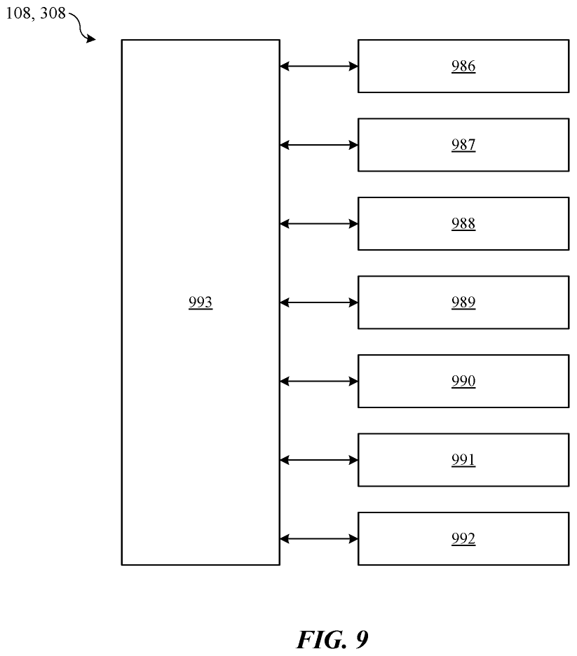

FIG. 9 is a block diagram that shows an example of the hardware for the control system 108, in one example the control system 308, as described above (referred to broadly as control system 108 for convenience only). The control system 108 is an example of a computing device that may be used to implement the control system 308 and/or other control systems of the vehicle 100 (e.g., control systems for the other vehicle systems identified and described in FIG. 1).

In the FIG. 9 example, the control system 108 may include a processor 986, a memory storage device 987, a controller 988, one or more input devices 989, one or more output devices 990, transmitter and/or receiving devices 991, and a power source 992. The control system 108 may include a bus 993 or a similar device to interconnect the components for communication.

The processor 986 is operable to execute computer program instructions and perform operations described by the computer program instructions. As an example, the processor 986 may be a conventional device such as a central processing unit. The memory storage device 987 may be a volatile, high-speed, short-term information storage device such as a random-access memory module. The memory storage device 987 may be a non-volatile information storage device such as a hard drive or a solid-state drive. The one or more input devices 989 may include any type of human-machine interface such as buttons, switches, a keyboard, a mouse, a touchscreen input device, a gestural input device, or an audio input device. The one or more output devices 990 may include any type of device operable to provide an indication to a user regarding an operating state, such as a display screen or an audio output, or any other functional output or control. The transmitter and/or receiving devices 991 may include any device which is capable of transmitting or receiving electronic signals through hardwire cables or wirelessly through conventional wireless communication protocols. The power source 992 may include a battery 109. Alternate or additional components may be included for control system 108 to suit the particular application as known by persons skilled in the art.

As described above, one aspect of the present technology is the control of a propulsion system for a vehicle, which may be incorporated in or used in conjunction with a device that includes the gathering and use of data available from various sources. As an example, such data may identify a user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores user preferences so that user settings can be applied automatically when the propulsion system for the vehicle is used. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, information needed to configure the propulsion system according to user preferences may be obtained each time the system is used and without subsequently storing the information or associating the information with the particular user.

What is claimed is:

1. A propulsion system comprising:
a battery that outputs direct current electrical power;
a first drivetrain comprising:
a first inverter that receives the direct current electrical power from the battery and generates a first alternating current electrical power output;
a first electric motor that is configured to be operated by the first alternating current electrical power output from the first inverter to rotate a first motor output shaft to provide a first motor input torque;
a first gearbox that receives the first motor input torque from the first motor output shaft and causes rotation of a first gearbox output shaft to provide a first gearbox output torque in response to the first motor input torque;
a second drivetrain comprising:
a second inverter that receives the direct current electrical power from the battery and generates a second alternating current electrical power output;
a second electric motor that is configured to be operated by the second alternating current electrical power output from the second inverter to rotate a second motor output shaft to provide a second motor input torque; and
a second gearbox that receives the second motor input torque from the second motor output shaft and causes rotation of a second gearbox output shaft to provide a second gearbox output torque in response to the second motor input torque.

2. The propulsion system of claim 1, wherein the first inverter receives the direct current electrical power from the battery through a first electrical circuit, the second inverter receives the direct current electrical power from the battery through a second electrical circuit, and the second electrical circuit is independent of the first electrical circuit.

3. The propulsion system of claim 2, wherein the first electrical circuit comprises a first fuse, the second electrical circuit comprises a second fuse, and the first drivetrain is fused separately with respect to the second drivetrain.

4. The propulsion system of claim 1, wherein the first electric motor is optimized for operation in a first operating speed range and a first torque range, and the second electric motor is optimized for operation in a second operating speed range and a second torque range, wherein at least part of the second operating speed range is higher than a maximum operating speed of the first operating speed range, and at least part of the first torque range is higher than a maximum torque of the second torque range.

5. The propulsion system of claim 4, wherein the first electric motor is positioned and configured to provide the first motor input torque to drive a wheel of a first wheel pair positioned toward a front of a vehicle.

6. The propulsion system of claim 4, wherein the first electric motor is positioned and configured to provide the first motor input torque to drive a wheel of a second wheel pair positioned toward a rear of a vehicle.

7. The propulsion system of claim 1, wherein the first drivetrain further comprises a first disconnect link configured to move between an engaged position in which the first electric motor provides the first motor input torque to drive a wheel of a first wheel pair, and a disengaged position in which the first electric motor does not provide the first motor input torque to the wheel of the first wheel pair.

8. The propulsion system of claim 1, wherein the second drivetrain further comprises a second disconnect link configured to move between an engaged position in which the second electric motor provides the second motor input torque to drive a wheel of a second wheel pair, and a disengaged position in which the second electric motor does not provide the second motor input torque to the wheel of the second wheel pair.

9. A propulsion system comprising:
a battery that outputs direct current electrical power;
a first drivetrain comprising:
a first inverter that is configured to generate a first alternating current electrical power output;
a first electrical circuit connecting the battery to the first inverter;
a first electric motor that is configured to be operated by the first alternating current electrical power output from the first inverter to rotate a first motor output shaft to provide a first motor input torque to a first gearbox;
a second drivetrain comprising:
a second inverter that receives the direct current electrical power from the battery and generates a second alternating current electrical power output;
a second electrical circuit connecting the battery to the second inverter, the second electrical circuit independent of the first electrical circuit;
a second electric motor that is configured to be operated by the second alternating current electrical power output from the second inverter to rotate a second motor output shaft to provide a second motor input torque;
a second gearbox;
a second disconnect link having an engaged position in which the second motor output shaft is connected to the second gearbox so that rotation of the second motor output shaft provides the second motor input torque to the second gearbox, and a disengaged position in which the second motor output shaft does not provide the second motor input torque to the second gearbox; and
a control system configured to detect a fault in the first drivetrain, the second drivetrain, or combinations thereof, and determine a response to the fault detected.

10. The propulsion system of claim 9, wherein the control system is configured to detect a vehicle speed, the control system configured to determine the response to the fault according to a vehicle base speed that is predetermined.

11. The propulsion system of claim 10, wherein the fault detected by the control system is a single switch short fault, a more than one switch short fault, or combinations thereof, in the first drivetrain, and wherein the vehicle speed detected is below the vehicle base speed, and the control system is configured to implement a three-phase short condition response to the fault detected in the first electric motor.

12. The propulsion system of claim 10, wherein the fault detected by the control system is a single switch open fault in the first drivetrain, and wherein the vehicle speed detected is below the vehicle base speed, and the control system is configured to implement a six switch open condition response to the fault detected in the first electric motor.

13. The propulsion system of claim 10, wherein the fault detected by the control system is a single switch short fault, a single switch open fault, a more than one switch short fault, a six switch open fault, or combinations thereof, in the first drivetrain, and wherein the vehicle speed detected is above the vehicle base speed, the control system is configured to implement a three-phase short condition response to the fault detected in the first electric motor.

14. The propulsion system of claim 9, wherein the fault detected is a single switch short fault, a single switch open fault, a more than one switch short fault, a six switch open fault, or combinations thereof, in the second drivetrain, and the control system is configured to implement one of a three-phase short condition response or a six switch open condition response to the fault detected in the second electric motor.

15. The propulsion system of claim 9, wherein the fault detected is a single switch short fault, a single switch open fault, a more than one switch short fault, a six switch open fault, or combinations thereof, in the second drivetrain, and the control system is configured to move the second disconnect link to the disengaged position to reduce electromagnetic drag torque by the second electric motor in response to detection of the fault.

16. The propulsion system of claim 9, wherein the fault detected is in the second drivetrain, and the control system is configured to move the second disconnect link to the disengaged position to reduce electromagnetic drag torque by the second electric motor in response to detection of the fault.

17. A propulsion system comprising:
one or more batteries that output direct current electrical power;
a first drivetrain comprising:
a first inverter that is configured to receive the direct current electrical power output from the one or more batteries and generates a first alternating current electrical power output;
a first electric motor that is configured to be operated by the first alternating current electrical power output from the first inverter to rotate a first motor output shaft to provide a first motor input torque to a first gearbox;
a second drivetrain comprising:
a second inverter that receives the direct current electrical power from the one or more batteries and generates a second alternating current electrical power output;
a second electric motor that is configured to be operated by the second alternating current electrical power output from the second inverter to rotate a second motor output shaft to provide a second motor input torque to a second gearbox; and
a control system configured to alternate between a first drivetrain operating mode, a second drivetrain operating mode, and a third drivetrain operating mode, wherein:
in the first drivetrain operating mode, the first electric motor provides the first motor input torque to the first gearbox, and the second electric motor does not provide the second motor input torque to the second gearbox,
in the second drivetrain operating mode, the second electric motor provides the second motor input torque to the second gearbox, and the first electric motor does not provide the first motor input torque to the first gearbox, and
in the third drivetrain operating mode, the first electric motor provides the first motor input torque to the first gearbox, and the second electric motor provides the second motor input torque to the second gearbox, the control system configured to alternate between the first drivetrain operating mode, the second drivetrain operating mode, and the third drivetrain operating mode.

18. The propulsion system of claim 17, wherein the second drivetrain further comprises a second disconnect link configured to move between an engaged position in which the second motor output shaft is connected to the second gearbox so that rotation of the second motor output shaft provides the second motor input torque to the second gearbox, and a disengaged position in which the second motor output shaft does not provide the second motor input torque to the second gearbox.

19. The propulsion system of claim 18, wherein when in the second drivetrain operating mode or the third drivetrain operating mode, in response to detection of a fault in the second drivetrain by the control system, the control system is operable to move the second disconnect link to the disengaged position to reduce electromagnetic drag torque by the second electric motor.

20. The propulsion system of claim 17, wherein:
the control system is configured to detect a fault in the first drivetrain, the second drivetrain, or combinations thereof, and determine a response to the fault detected, and
in the first drivetrain operating mode or the third drivetrain operating mode, on detection in the first drivetrain of a single switch short fault, a more than one switch short fault, or combinations thereof, the control system is configured to implement a three-phase short condition response to the fault detected.

21. The propulsion system of claim 17, wherein:
the control system is configured to detect a fault in the first drivetrain, the second drivetrain, or combinations thereof, and determine a response to the fault detected, and
in the first drivetrain operating mode or the third drivetrain operating mode, on detection in the first drivetrain of a single switch open fault or a six switch open fault, the control system is configured to implement one of a six switch open condition response, a three-phase short condition response, or a no reaction response.
